(19) United States
(12) Patent Application Publication
(10) Pub. No.: US 2025/0159628 A1
(43) Pub. Date: May 15, 2025

(54) TRANSMISSION AND RECEPTION OF SUB-BAND SS/PBCH BLOCKS

(71) Applicant: Samsung Electronics Co., Ltd., Suwon-si (KR)

(72) Inventors: Emad Nader Farag, Flanders, NJ (US); Hongbo Si, Allen, TX (US); Dalin Zhu, Allen, TX (US); Eko Onggosanusi, Coppell, TX (US)

(21) Appl. No.: 18/924,954

(22) Filed: Oct. 23, 2024

Related U.S. Application Data
(60) Provisional application No. 63/548,100, filed on Nov. 10, 2023.
(60) Provisional application No. 63/651,840, filed on May 24, 2024.

(51) Int. Cl. H04W 56/00; H04L 5/00; H04W 16/28

(52) U.S. Cl. CPC H04W 56/0015; H04L 5/0012; H04W 16/28

(57) ABSTRACT

Methods and apparatuses for transmission and reception of sub-band synchronization signal/physical broadcast channel (SS/PBCH) blocks (SSBs) t. A method of operating a user equipment (UE) includes searching SSB indices in SSB occasions. The SSB occasions are organized in SSB groups. An SSB group of the SSB groups includes N SSB indices in N SSB occasions. The SSB group spans M frequency occasions and K time occasions, where N≤M·K, and M>1. The method further includes receiving, in frequency occasion m1ᵢ and in time occasion k1ᵢ, SSB index i in a first SSB group with index s₁ and receiving, in frequency occasion m2ᵢ and in time occasion k2ᵢ, SSB index i in a second SSB group with index s₂. The frequency occasions are different.

### CROSS-REFERENCE TO RELATED AND CLAIM OF PRIORITY

The present application claims priority under 35 U.S.C. § 119(e) to U.S. Provisional Patent Application No. 63/548,100 filed on Nov. 10, 2023, and U.S. Provisional Patent Application No. 63/651,840 filed on May 24, 2024, which are hereby incorporated by reference in their entirety.

### TECHNICAL FIELD

The present disclosure relates generally to wireless communication systems and, more specifically, the present disclosure relates to methods and apparatuses for transmitting and receiving sub-band synchronization signal/physical broadcast channel (SS/PBCH) blocks (SSBs).

### BACKGROUND

Wireless communication has been one of the most successful innovations in modern history. Recently, the number of subscribers to wireless communication services exceeded five billion and continues to grow quickly. The demand of wireless data traffic is rapidly increasing due to the growing popularity among consumers and businesses of smart phones and other mobile data devices, such as tablets, “note pad” computers, net books, eBook readers, and machine type of devices. In order to meet the high growth in mobile data traffic and support new applications and deployments, improvements in radio interface efficiency and coverage are of paramount importance. To meet the demand for wireless data traffic having increased since deployment of 4G communication systems, and to enable various vertical applications, 5G communication systems have been developed and are currently being deployed.

### SUMMARY

The present disclosure relates to transmissions and receptions of sub-band SSBs.

In one embodiment, a user equipment (UE) is provided. The UE includes a processor configured to search SSB indices in SSB occasions. The SSB occasions are organized in SSB groups. An SSB group of the SSB groups includes N SSB indices in N SSB occasions. The SSB group spans M frequency occasions and K time occasions, where N≤M·K, and M>1. The UE further includes a transceiver operably coupled to the processor. The transceiver is configured to receive, in frequency occasion m1ᵢ and in time occasion k1ᵢ, SSB index i in a first SSB group with index s₁ and receive, in frequency occasion m2ᵢ and in time occasion k2ᵢ, SSB index i in a second SSB group with index s₂.

In another embodiment, a base station (BS) is provided. The BS includes a processor and a transceiver operably to the processor. The transceiver is configured to transmit SSB indices in SSB occasions. The SSB occasions are organized in SSB groups. An SSB group of the SSB groups includes N SSB indices in N SSB occasions. The SSB group spans M frequency occasions and K time occasions, where N≤M·K, and M>1. SSB index i in a first SSB group with index s₁ is transmitted in frequency occasion m1ᵢ and in time occasion k1ᵢ. SSB index i in a second SSB group with index s₂ is transmitted in frequency occasion m2ᵢ and in time occasion k2ᵢ.

In yet another embodiment, a method of operating a UE is provided. The method includes searching SSB indices in SSB occasions. The SSB occasions are organized in SSB groups. An SSB group of the SSB groups includes N SSB indices in N SSB occasions. The SSB group spans M frequency occasions and K time occasions, where N≤M·K, and M>1. The method further includes receiving, in frequency occasion m1ᵢ and in time occasion k1ᵢ, SSB index i in a first SSB group with index s₁ and receiving, in frequency occasion m2ᵢ and in time occasion k2ᵢ, SSB index i in a second SSB group with index s₂.

Other technical features may be readily apparent to one skilled in the art from the following figures, descriptions, and claims.

Before undertaking the DETAILED DESCRIPTION below, it may be advantageous to set forth definitions of certain words and phrases used throughout this patent document. The term “couple” and its derivatives refer to any direct or indirect communication between two or more elements, whether or not those elements are in physical contact with one another. The terms “transmit,” “receive,” and “communicate,” as well as derivatives thereof, encompass both direct and indirect communication. The terms “include” and “comprise,” as well as derivatives thereof, mean inclusion without limitation. The term “or” is inclusive, meaning and/or. The phrase “associated with,” as well as derivatives thereof, means to include, be included within, interconnect with, contain, be contained within, connect to or with, couple to or with, be communicable with, cooperate with, interleave, juxtapose, be proximate to, be bound to or with, have, have a property of, have a relationship to or with, or the like. The term “controller” means any device, system, or part thereof that controls at least one operation. Such a controller may be implemented in hardware or a combination of hardware and software and/or firmware. The functionality associated with any particular controller may be centralized or distributed, whether locally or remotely. The phrase “at least one of,” when used with a list of items, means that different combinations of one or more of the listed items may be used, and only one item in the list may be needed. For example, “at least one of: A, B, and C” includes any of the following combinations: A, B, C, A and B, A and C, B and C, and A and B and C.

Moreover, various functions described below can be implemented or supported by one or more computer programs, each of which is formed from computer readable program code and embodied in a computer readable medium. The terms “application” and “program” refer to one or more computer programs, software components, sets of instructions, procedures, functions, objects, classes, instances, related data, or a portion thereof adapted for implementation in a suitable computer readable program code. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

Definitions for other certain words and phrases are provided throughout this patent document. Those of ordinary skill in the art should understand that in many if not most instances, such definitions apply to prior as well as future uses of such defined words and phrases.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIG. 1 illustrates an example wireless network according to embodiments of the present disclosure;

FIG. 2 illustrates an example gNodeB (gNB) according to embodiments of the present disclosure;

FIG. 3 illustrates an example UE according to embodiments of the present disclosure;

FIGS. 4A and 4B illustrates an example of a wireless transmit and receive paths according to embodiments of the present disclosure;

FIG. 5A illustrates an example of a wireless system according to embodiments of the present disclosure;

FIG. 5B illustrates an example of a multi-beam operation according to embodiments of the present disclosure;

FIG. 6 illustrates an example of a transmitter structure for beamforming according to embodiments of the present disclosure;

FIG. 7A illustrates a diagram of an example joint phase-time arrays (JPTA) circuit according to embodiments of the present disclosure;

FIG. 7B illustrates an example of JPTA beamforming according to embodiments of the present disclosure;

FIGS. 8A and 8B illustrate examples of SSB groups according to embodiments of the present disclosure;

FIG. 9 illustrates an example of a timeline for mapping synchronization signal blocks (SSBs) to beams and sub-bands according to embodiments of the present disclosure;

FIGS. 10A and 10B illustrate an example of a timeline for mapping SSBs to beams and sub-bands according to embodiments of the present disclosure;

FIGS. 11A, 11B, and 11C illustrate an example of a timeline for mapping SSBs to beams and sub-bands according to embodiments of the present disclosure;

FIGS. 12A and 12B illustrate an example of a timeline for mapping SSBs to beams and sub-bands according to embodiments of the present disclosure;

FIGS. 13A and 13B illustrate an example of a timeline for mapping SSBs to beams and sub-bands according to embodiments of the present disclosure;

FIGS. 14A and 14B illustrate an example of a timeline for mapping SSBs to beams and sub-bands according to embodiments of the present disclosure;

FIGS. 15A and 15B illustrate an example of a timeline for mapping SSBs to beams and sub-bands according to embodiments of the present disclosure; and

FIG. 16 illustrates an example method performed by a UE in a wireless communication system according to embodiments of the present disclosure.

### DETAILED DESCRIPTION

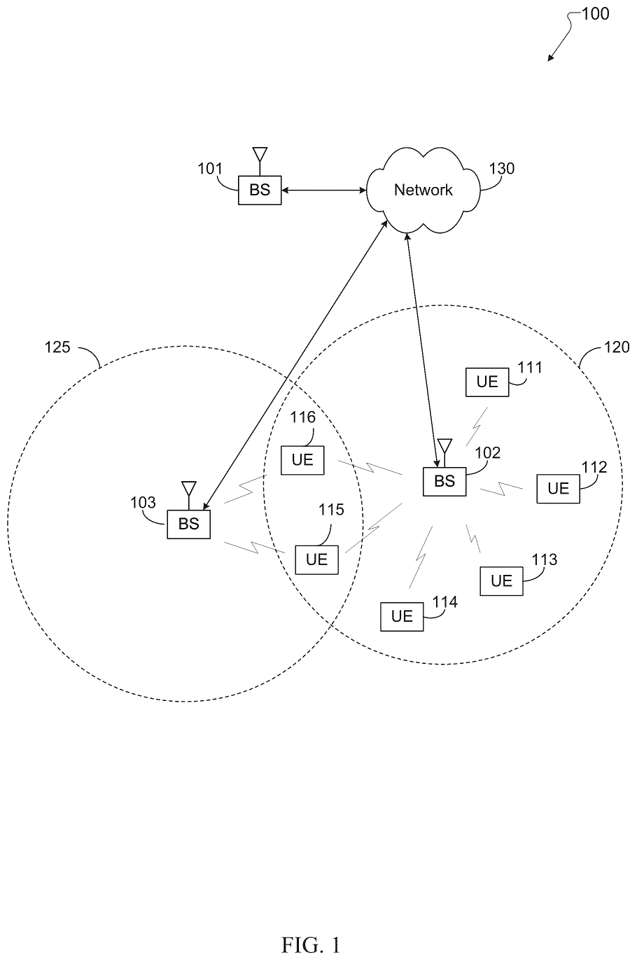

FIGS. 1-16, discussed below, and the various, non-limiting embodiments used to describe the principles of the present disclosure in this patent document are by way of illustration only and should not be construed in any way to limit the scope of the disclosure. Those skilled in the art will understand that the principles of the present disclosure may be implemented in any suitably arranged system or device.

To meet the demand for wireless data traffic having increased since deployment of 4G communication systems, and to enable various vertical applications, 5G/NR communication systems have been developed and are currently being deployed. The 5G/NR communication system is implemented in higher frequency (mmWave) bands, e.g., 28 GHz or 60 GHz bands, so as to accomplish higher data rates or in lower frequency bands, such as 6 GHz, to enable robust coverage and mobility support. To decrease propagation loss of the radio waves and increase the transmission distance, the beamforming, massive multiple-input multiple-output (MIMO), full dimensional MIMO (FD-MIMO), array antenna, an analog beam forming, large scale antenna techniques are discussed in 5G/NR communication systems.

In addition, in 5G/NR communication systems, development for system network improvement is under way based on advanced small cells, cloud radio access networks (RANs), ultra-dense networks, device-to-device (D2D) communication, wireless backhaul, moving network, cooperative communication, coordinated multi-points (CoMP), reception-end interference cancelation and the like.

The discussion of 5G systems and frequency bands associated therewith is for reference as certain embodiments of the present disclosure may be implemented in 5G systems. However, the present disclosure is not limited to 5G systems, or the frequency bands associated therewith, and embodiments of the present disclosure may be utilized in connection with any frequency band. For example, aspects of the present disclosure may also be applied to deployment of 5G communication systems, 6G, or even later releases which may use terahertz (THz) bands.

The following documents and standards descriptions are hereby incorporated by reference into the present disclosure as if fully set forth herein: [1] 3GPP TS 38.211 v18.3.0, “NR; Physical channels and modulation;” [2] 3GPP TS 38.212 v18.3.0, “NR; Multiplexing and Channel coding;” [3] 3GPP TS 38.213 v18.3.0, “NR; Physical Layer Procedures for Control;” [4] 3GPP TS 38.214 v18.3.0, “NR; Physical Layer Procedures for Data;” [5] 3GPP TS 38.321 v18.2.0, “NR; Medium Access Control (MAC) protocol specification;” [6] 3GPP TS 38.331 v18.2.0, “NR; Radio Resource Control (RRC) Protocol Specification;” and [7] 3GPP RP-202024, “Revised WID: Further enhancements on MIMO for NR.”

FIGS. 1-3 below describe various embodiments implemented in wireless communications systems and with the use of orthogonal frequency division multiplexing (OFDM) or orthogonal frequency division multiple access (OFDMA) communication techniques. The descriptions of FIGS. 1-3 are not meant to imply physical or architectural limitations to how different embodiments may be implemented. Different embodiments of the present disclosure may be implemented in any suitably arranged communications system.

FIG. 1 illustrates an example wireless network 100 according to embodiments of the present disclosure. The embodiment of the wireless network 100 shown in FIG. 1 is for illustration only. Other embodiments of the wireless network 100 could be used without departing from the scope of this disclosure.

As shown in FIG. 1, the wireless network 100 includes a gNB 101 (e.g., base station, BS), a gNB 102, and a gNB 103. The gNB 101 communicates with the gNB 102 and the gNB 103. The gNB 101 also communicates with at least one network 130, such as the Internet, a proprietary Internet Protocol (IP) network, or other data network.

The gNB 102 provides wireless broadband access to the network 130 for a first plurality of user equipments (UEs) within a coverage area 120 of the gNB 102. The first plurality of UEs includes a UE 111, which may be located in a small business; a UE 112, which may be located in an enterprise; a UE 113, which may be a WiFi hotspot; a UE 114, which may be located in a first residence; a UE 115, which may be located in a second residence; and a UE 116, which may be a mobile device, such as a cell phone, a wireless laptop, a wireless PDA, or the like. The gNB 103 provides wireless broadband access to the network 130 for a second plurality of UEs within a coverage area 125 of the gNB 103. The second plurality of UEs includes the UE 115 and the UE 116. In some embodiments, one or more of the gNBs 101-103 may communicate with each other and with the UEs 111-116 using 5G/NR, long term evolution (LTE), long term evolution-advanced (LTE-A), WiMAX, WiFi, or other wireless communication techniques.

Depending on the network type, the term “base station” or “BS” can refer to any component (or collection of components) configured to provide wireless access to a network, such as transmit point (TP), transmit-receive point (TRP), an enhanced base station (eNodeB or eNB), a 5G/NR base station (gNB), a macrocell, a femtocell, a WiFi access point (AP), or other wirelessly enabled devices. Base stations may provide wireless access in accordance with one or more wireless communication protocols, e.g., 5G/NR 3^{rd} generation partnership project (3GPP) NR, long term evolution (LTE), LTE advanced (LTE-A), high speed packet access (HSPA), Wi-Fi 802.11a/b/g/n/ac, etc. For the sake of convenience, the terms “BS” and “TRP” are used interchangeably in this patent document to refer to network infrastructure components that provide wireless access to remote terminals. Also, depending on the network type, the term “user equipment” or “UE” can refer to any component such as “mobile station,” “subscriber station,” “remote terminal,” “wireless terminal,” “receive point,” or “user device.” For the sake of convenience, the terms “user equipment” and “UE” are used in this patent document to refer to remote wireless equipment that wirelessly accesses a BS, whether the UE is a mobile device (such as a mobile telephone or smartphone) or is normally considered a stationary device (such as a desktop computer or vending machine).

The dotted lines show the approximate extents of the coverage areas 120 and 125, which are shown as approximately circular for the purposes of illustration and explanation only. It should be clearly understood that the coverage areas associated with gNBs, such as the coverage areas 120 and 125, may have other shapes, including irregular shapes, depending upon the configuration of the gNBs and variations in the radio environment associated with natural and man-made obstructions.

As described in more detail below, one or more of the UEs 111-116 include circuitry, programing, or a combination thereof for receiving sub-band SSBs. In certain embodiments, one or more of the BSs 101-103 include circuitry, programing, or a combination thereof to perform sub-band SSB transmissions.

Although FIG. 1 illustrates one example of a wireless network, various changes may be made to FIG. 1. For example, the wireless network 100 could include any number of gNBs and any number of UEs in any suitable arrangement. Also, the gNB 101 could communicate directly with any number of UEs and provide those UEs with wireless broadband access to the network 130. Similarly, each gNB 102-103 could communicate directly with the network 130 and provide UEs with direct wireless broadband access to the network 130. Further, the gNBs 101, 102, and/or 103 could provide access to other or additional external networks, such as external telephone networks or other types of data networks.

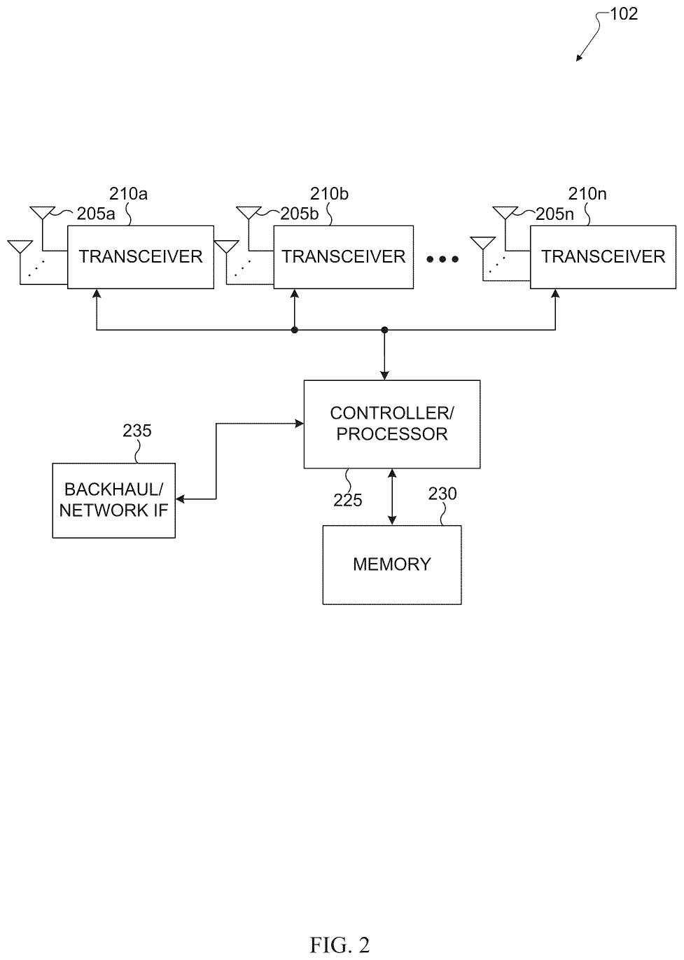

FIG. 2 illustrates an example gNB 102 according to embodiments of the present disclosure. The embodiment of the gNB 102 illustrated in FIG. 2 is for illustration only, and the gNBs 101 and 103 of FIG. 1 could have the same or similar configuration. However, gNBs come in a wide variety of configurations, and FIG. 2 does not limit the scope of this disclosure to any particular implementation of a gNB.

As shown in FIG. 2, the gNB 102 includes multiple antennas 205a-205n, multiple transceivers 210a-210n, a controller/processor 225, a memory 230, and a backhaul or network interface 235.

The transceivers 210a-210n receive, from the antennas 205a-205n, incoming radio frequency (RF) signals, such as signals transmitted by UEs in the wireless network 100. The transceivers 210a-210n down-convert the incoming RF signals to generate IF or baseband signals. The IF or baseband signals are processed by receive (RX) processing circuitry in the transceivers 210a-210n and/or controller/processor 225, which generates processed baseband signals by filtering, decoding, and/or digitizing the baseband or IF signals. The controller/processor 225 may further process the baseband signals.

Transmit (TX) processing circuitry in the transceivers 210a-210n and/or controller/processor 225 receives analog or digital data (such as voice data, web data, e-mail, or interactive video game data) from the controller/processor 225. The TX processing circuitry encodes, multiplexes, and/or digitizes the outgoing baseband data to generate processed baseband or IF signals. The transceivers 210a-210n up-converts the baseband or IF signals to RF signals that are transmitted via the antennas 205a-205n.

The controller/processor 225 can include one or more processors or other processing devices that control the overall operation of the gNB 102. For example, the controller/processor 225 could control the reception of uplink (UL) channel signals and the transmission of downlink (DL) channel signals by the transceivers 210a-210n in accordance with well-known principles. The controller/processor 225 could support additional functions as well, such as more advanced wireless communication functions. For instance, the controller/processor 225 could support beam forming or directional routing operations in which outgoing/incoming signals from/to multiple antennas 205a-205n are weighted differently to effectively steer the outgoing signals in a desired direction. Any of a wide variety of other functions could be supported in the gNB 102 by the controller/processor 225.

The controller/processor 225 is also capable of executing programs and other processes resident in the memory 230, such as performing sub-band SSB transmissions. The controller/processor 225 can move data into or out of the memory 230 as required by an executing process.

The controller/processor 225 is also coupled to the backhaul or network interface 235. The backhaul or network interface 235 allows the gNB 102 to communicate with other devices or systems over a backhaul connection or over a network. The interface 235 could support communications over any suitable wired or wireless connection(s). For example, when the gNB 102 is implemented as part of a cellular communication system (such as one supporting 5G/NR, LTE, or LTE-A), the interface 235 could allow the gNB 102 to communicate with other gNBs over a wired or wireless backhaul connection. When the gNB 102 is implemented as an access point, the interface 235 could allow the gNB 102 to communicate over a wired or wireless local area network or over a wired or wireless connection to a larger network (such as the Internet). The interface 235 includes any suitable structure supporting communications over a wired or wireless connection, such as an Ethernet or transceiver.

The memory 230 is coupled to the controller/processor 225. Part of the memory 230 could include a RAM, and another part of the memory 230 could include a Flash memory or other ROM.

Although FIG. 2 illustrates one example of gNB 102, various changes may be made to FIG. 2. For example, the gNB 102 could include any number of each component shown in FIG. 2. Also, various components in FIG. 2 could be combined, further subdivided, or omitted and additional components could be added according to particular needs.

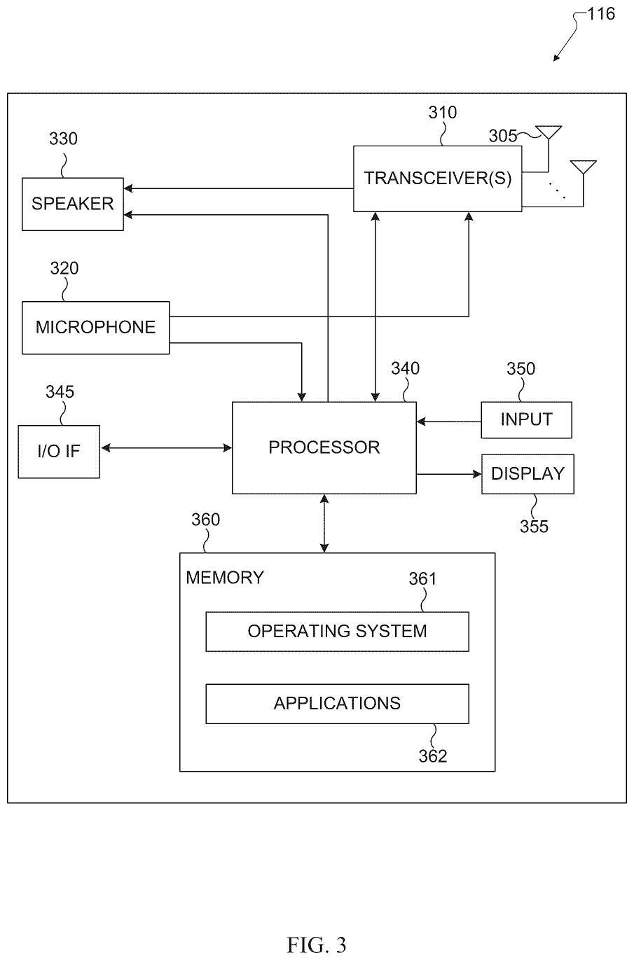

FIG. 3 illustrates an example UE 116 according to embodiments of the present disclosure. The embodiment of the UE 116 illustrated in FIG. 3 is for illustration only, and the UEs 111-115 of FIG. 1 could have the same or similar configuration. However, UEs come in a wide variety of configurations, and FIG. 3 does not limit the scope of this disclosure to any particular implementation of a UE.

As shown in FIG. 3, the UE 116 includes antenna(s) 305, a transceiver(s) 310, and a microphone 320. The UE 116 also includes a speaker 330, a processor 340, an input/output (I/O) interface (IF) 345, an input 350, a display 355, and a memory 360. The memory 360 includes an operating system (OS) 361 and one or more applications 362.

The transceiver(s) 310 receives from the antenna(s) 305, an incoming RF signal transmitted by a gNB of the wireless network 100. The transceiver(s) 310 down-converts the incoming RF signal to generate an intermediate frequency (IF) or baseband signal. The IF or baseband signal is processed by RX processing circuitry in the transceiver(s) 310 and/or processor 340, which generates a processed baseband signal by filtering, decoding, and/or digitizing the baseband or IF signal. The RX processing circuitry sends the processed baseband signal to the speaker 330 (such as for voice data) or is processed by the processor 340 (such as for web browsing data).

TX processing circuitry in the transceiver(s) 310 and/or processor 340 receives analog or digital voice data from the microphone 320 or other outgoing baseband data (such as web data, e-mail, or interactive video game data) from the processor 340. The TX processing circuitry encodes, multiplexes, and/or digitizes the outgoing baseband data to generate a processed baseband or IF signal. The transceiver(s) 310 up-converts the baseband or IF signal to an RF signal that is transmitted via the antenna(s) 305.

The processor 340 can include one or more processors or other processing devices and execute the OS 361 stored in the memory 360 in order to control the overall operation of the UE 116. For example, the processor 340 could control the reception of DL channels or signals and the transmission of UL channels or signals by the transceiver(s) 310 in accordance with well-known principles. In some embodiments, the processor 340 includes at least one microprocessor or microcontroller.

The processor 340 is also capable of executing other processes and programs resident in the memory 360. For example, the processor 340 may execute processes to identify and control reception of sub-band SSBs as described in embodiments of the present disclosure. The processor 340 can move data into or out of the memory 360 as required by an executing process. In some embodiments, the processor 340 is configured to execute the applications 362 based on the OS 361 or in response to signals received from gNBs or an operator. The processor 340 is also coupled to the I/O interface 345, which provides the UE 116 with the ability to connect to other devices, such as laptop computers and handheld computers. The VO interface 345 is the communication path between these accessories and the processor 340.

The processor 340 is also coupled to the input 350, which includes, for example, a touchscreen, keypad, etc., and the display 355. The operator of the UE 116 can use the input 350 to enter data into the UE 116. The display 355 may be a liquid crystal display, light emitting diode display, or other display capable of rendering text and/or at least limited graphics, such as from web sites.

The memory 360 is coupled to the processor 340. Part of the memory 360 could include a random-access memory (RAM), and another part of the memory 360 could include a Flash memory or other read-only memory (ROM).

Although FIG. 3 illustrates one example of UE 116, various changes may be made to FIG. 3. For example, various components in FIG. 3 could be combined, further subdivided, or omitted and additional components could be added according to particular needs. As a particular example, the processor 340 could be divided into multiple processors, such as one or more central processing units (CPUs) and one or more graphics processing units (GPUs). In another example, the transceiver(s) 310 may include any number of transceivers and signal processing chains and may be connected to any number of antennas. Also, while FIG. 3 illustrates the UE 116 configured as a mobile telephone or smartphone, UEs could be configured to operate as other types of mobile or stationary devices.

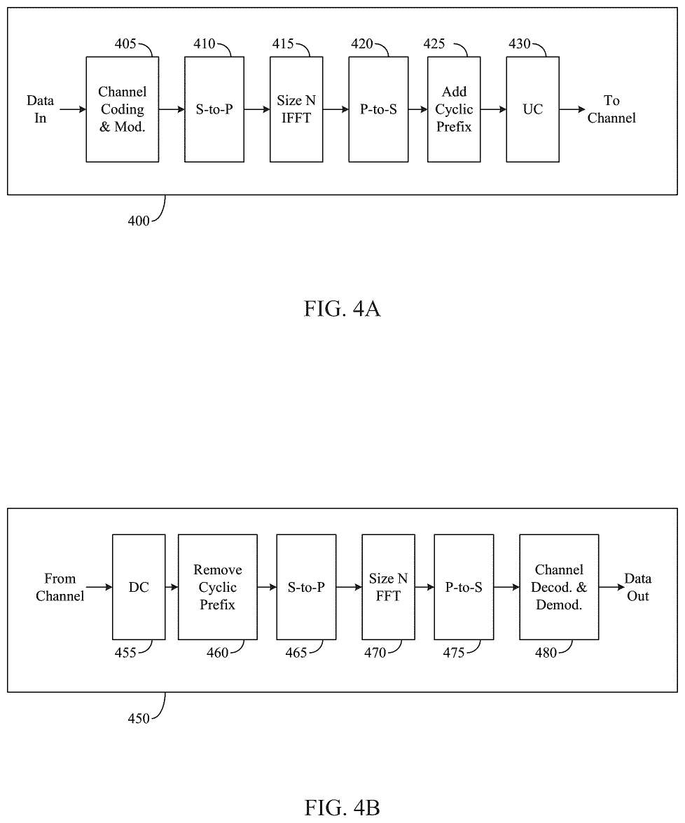

FIG. 4A and FIG. 4B illustrate an example of wireless transmit and receive paths 400 and 450, respectively, according to embodiments of the present disclosure. For example, a transmit path 400 may be described as being implemented in a gNB (such as gNB 102), while a receive path 450 may be described as being implemented in a UE (such as UE 116). However, it will be understood that the receive path 450 can be implemented in a gNB and that the transmit path 400 can be implemented in a UE. In some embodiments, the transmit path 400 or receive path 450 is configured to support sub-band SSB transmissions or receptions, respectively, as described in embodiments of the present disclosure.

As illustrated in FIG. 4A, the transmit path 400 includes a channel coding and modulation block 405, a serial-to-parallel (S-to-P) block 410, a size N Inverse Fast Fourier Transform (IFFT) block 415, a parallel-to-serial (P-to-S) block 420, an add cyclic prefix block 425, and an up-converter (UC) 430. The receive path 450 includes a down-converter (DC) 455, a remove cyclic prefix block 460, a S-to-P block 465, a size N Fast Fourier Transform (FFT) block 470, a parallel-to-serial (P-to-S) block 475, and a channel decoding and demodulation block 480.

In the transmit path 400, the channel coding and modulation block 405 receives a set of information bits, applies coding (such as a low-density parity check (LDPC) coding), and modulates the input bits (such as with Quadrature Phase Shift Keying (QPSK) or Quadrature Amplitude Modulation (QAM)) to generate a sequence of frequency-domain modulation symbols. The serial-to-parallel block 410 converts (such as de-multiplexes) the serial modulated symbols to parallel data in order to generate N parallel symbol streams, where N is the IFFT/FFT size used in the gNB 102 and the UE 116. The size N IFFT block 415 performs an IFFT operation on the N parallel symbol streams to generate time-domain output signals. The parallel-to-serial block 420 converts (such as multiplexes) the parallel time-domain output symbols from the size N IFFT block 415 in order to generate a serial time-domain signal. The add cyclic prefix block 425 inserts a cyclic prefix to the time-domain signal. The up-converter 430 modulates (such as up-converts) the output of the add cyclic prefix block 425 to a RF frequency for transmission via a wireless channel. The signal may also be filtered at a baseband before conversion to the RF frequency.

As illustrated in FIG. 4B, the down-converter 455 down-converts the received signal to a baseband frequency, and the remove cyclic prefix block 460 removes the cyclic prefix to generate a serial time-domain baseband signal. The serial-to-parallel block 465 converts the time-domain baseband signal to parallel time-domain signals. The size N FFT block 470 performs an FFT algorithm to generate N parallel frequency-domain signals. The (P-to-S) block 475 converts the parallel frequency-domain signals to a sequence of modulated data symbols. The channel decoding and demodulation block 480 demodulates and decodes the modulated symbols to recover the original input data stream.

Each of the gNBs 101-103 may implement a transmit path 400 that is analogous to transmitting in the downlink to UEs 111-116 and may implement a receive path 450 that is analogous to receiving in the uplink from UEs 111-116. Similarly, each of UEs 111-116 may implement a transmit path 400 for transmitting in the uplink to gNBs 101-103 and may implement a receive path 450 for receiving in the downlink from gNBs 101-103.

Each of the components in FIGS. 4A and 4B can be implemented using only hardware or using a combination of hardware and software/firmware. As a particular example, at least some of the components in FIGS. 4A and 4B may be implemented in software, while other components may be implemented by configurable hardware or a mixture of software and configurable hardware. For instance, the FFT block 470 and the IFFT block 415 may be implemented as configurable software algorithms, where the value of size N may be modified according to the implementation.

Furthermore, although described as using FFT and IFFT, this is by way of illustration only and should not be construed to limit the scope of this disclosure. Other types of transforms, such as Discrete Fourier Transform (DFT) and Inverse Discrete Fourier Transform (IDFT) functions, can be used. It will be appreciated that the value of the variable N may be any integer number (such as 1, 2, 3, 4, or the like) for DFT and IDFT functions, while the value of the variable N may be any integer number that is a power of two (such as 1, 2, 4, 8, 16, or the like) for FFT and IFFT functions.

Although FIGS. 4A and 4B illustrate examples of wireless transmit and receive paths 400 and 450, respectively, various changes may be made to FIGS. 4A and 4B. For example, various components in FIGS. 4A and 4B can be combined, further subdivided, or omitted and additional components can be added according to particular needs. Also, FIGS. 4A and 4B are meant to illustrate examples of the types of transmit and receive paths that can be used in a wireless network. Any other suitable architectures can be used to support wireless communications in a wireless network.

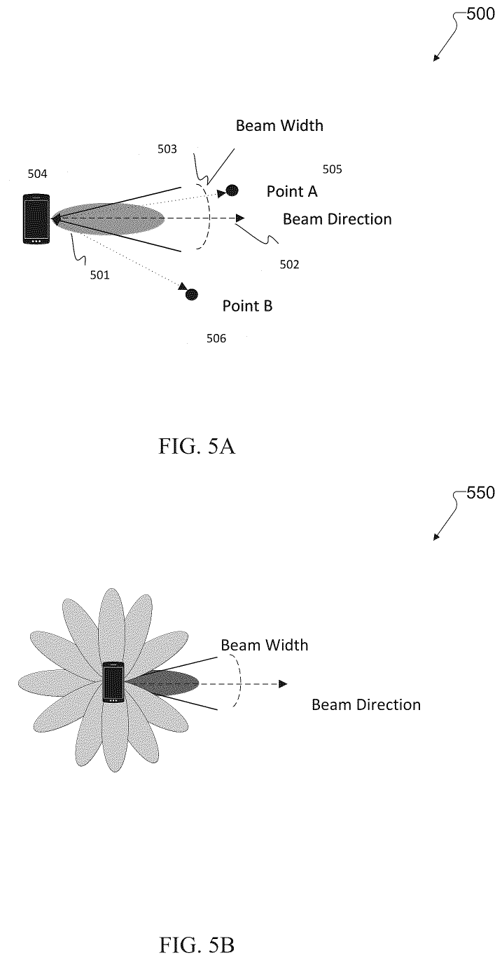

As illustrated in FIG. 5A, in a wireless system 500, a beam 501 for a device 504 can be characterized by a beam direction 502 and a beam width 503. For example, the device 504 (or UE 116) transmits RF energy in a beam direction and within a beam width. The device 504 receives RF energy in a beam direction and within a beam width. As illustrated in FIG. 5A, a device at point A 505 can receive from and transmit to device 504 as Point A is within a beam width and direction of a beam from device 504. As illustrated in FIG. 5A, a device at point B 506 cannot receive from and transmit to device 504 as Point B 506 is outside a beam width and direction of a beam from device 504. While FIG. 5A, for illustrative purposes, shows a beam in 2-dimensions (2D), it should be apparent to those skilled in the art, that a beam can be in 3-dimensions (3D), where the beam direction and beam width are defined in space.

FIG. 5B illustrates an example of a multi-beam operation 550 according to embodiments of the present disclosure. For example, the multi-beam operation 550 can be utilized by UE 116 of FIG. 3. This example is for illustration only and other embodiments can be used without departing from the scope of the present disclosure.

In a wireless system, a device can transmit and/or receive on multiple beams. This is known as “multi-beam operation”. While FIG. 5B, for illustrative purposes, a beam is in 2D, it should be apparent to those skilled in the art, that a beam can be 3D, where a beam can be transmitted to or received from any direction in space.

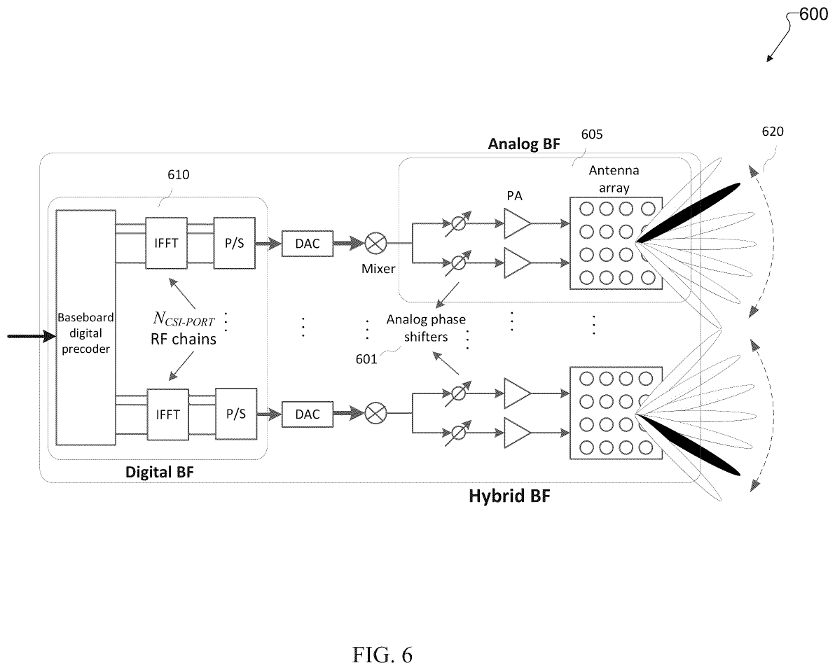

FIG. 6 illustrates an example of a transmitter structure 600 for beamforming according to embodiments of the present disclosure. In certain embodiments, one or more of gNB 102 or UE 116 includes the transmitter structure 600. For example, one or more of antenna 205 and its associated systems or antenna 305 and its associated systems can be included in transmitter structure 600. This example is for illustration only and other embodiments can be used without departing from the scope of the present disclosure.

Accordingly, embodiments of the present disclosure recognize that Rel-14 LTE and Rel-15 NR support up to 32 channel state indication reference signal (CSI-RS) antenna ports which enable an eNB or a gNB to be equipped with a large number of antenna elements (such as 64 or 128). A plurality of antenna elements can then be mapped onto one CSI-RS port. For mmWave bands, although a number of antenna elements can be larger for a given form factor, a number of CSI-RS ports, that can correspond to the number of digitally precoded ports, can be limited due to hardware constraints (such as the feasibility to install a large number of analog-to-digital converters (ADCs)/digital-to-analog converters (DACs) at mmWave frequencies) as illustrated in FIG. 6. Then, one CSI-RS port can be mapped onto a large number of antenna elements that can be controlled by a bank of analog phase shifters 601. One CSI-RS port can then correspond to one sub-array which produces a narrow analog beam through analog beamforming 605. This analog beam can be configured to sweep across a wider range of angles 620 by varying the phase shifter bank across symbols or slots/subframes. The number of sub-arrays (equal to the number of RF chains) is the same as the number of CSI-RS ports N_{CSI-PORT}. A digital beamforming unit 610 performs a linear combination across N_{CSI-PORT} analog beams to further increase a precoding gain. While analog beams are wideband (hence not frequency-selective), digital precoding can be varied across frequency sub-bands or resource blocks. Receiver operation can be conceived analogously.

Since the transmitter structure 600 of FIG. 6 utilizes multiple analog beams for transmission and reception (wherein one or a small number of analog beams are selected out of a large number, for instance, after a training duration that is occasionally or periodically performed), the term “multi-beam operation” is used to refer to the overall system aspect. This includes, for the purpose of illustration, indicating the assigned DL or UL TX beam (also termed “beam indication”), measuring at least one reference signal for calculating and performing beam reporting (also termed “beam measurement” and “beam reporting”, respectively), and receiving a DL or UL transmission via a selection of a corresponding RX beam. The system of FIG. 6 is also applicable to higher frequency bands such as >52.6 GHz. In this case, the system can employ only analog beams. Due to the O2 absorption loss around 60 GHz frequency (˜10 dB additional loss per 100 m distance), a larger number and narrower analog beams (hence a larger number of radiators in the array) are needed to compensate for the additional path loss.

The text and figures are provided solely as examples to aid the reader in understanding the present disclosure. They are not intended and are not to be construed as limiting the scope of the present disclosure in any manner. Although certain embodiments and examples have been provided, it will be apparent to those skilled in the art based on the disclosures herein that changes in the embodiments and examples shown may be made without departing from the scope of the present disclosure. The transmitter structure 600 for beamforming is for illustration only and other embodiments can be used without departing from the scope of the present disclosure.

Although the figures illustrate different examples of user equipment, various changes may be made to the figures. For example, the user equipment can include any number of each component in any suitable arrangement. In general, the figures do not limit the scope of this disclosure to any particular configuration(s). Moreover, while figures illustrate operational environments in which various user equipment features disclosed in this patent document can be used, these features can be used in any other suitable system.

Any of the above variation embodiments can be utilized independently or in combination with at least one other variation embodiment.

Although the present disclosure has been described with exemplary embodiments, various changes and modifications may be suggested to one skilled in the art. It is intended that the present disclosure encompass such changes and modifications as fall within the scope of the appended claims. None of the descriptions in this application should be read as implying that any particular element, step, or function is an essential element that must be included in the claims scope. The scope of subject matter is defined by the claims.

In this disclosure, a beam is determined by either of,
A transmission configuration indication (TCI) state, that establishes a quasi-colocation (QCL) relationship or spatial relation between a source reference signal (e.g. SSB and/or CSI-RS) and a target reference signal
A spatial relation information that establishes an association to a source reference signal, such as SSB or CSI-RS or sounding reference signal (SRS).

In either case, the ID of the source reference signal or the ID of the TCI state or the ID of the spatial relation identifies the beam.

The TCI state and/or the spatial relation reference RS can determine a spatial Rx filter for reception of downlink channels or signals at the UE, or a spatial Tx filter for transmission of uplink channels or signals from the UE. The TCI state and/or the spatial relation reference RS can determine a spatial Tx filter for transmission of downlink channels or signals from the gNB, or a spatial Rx filter for reception of uplink channels or signals at the gNB.

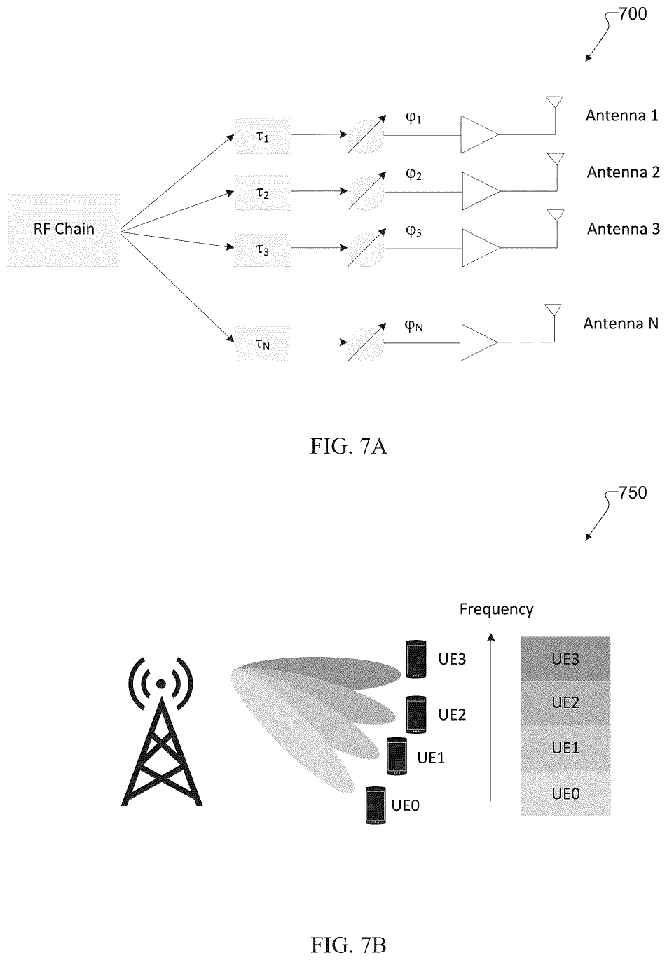

FIG. 7A illustrates a diagram of an example JPTA circuit 700 according to embodiments of the present disclosure. For example, the JPTA circuit 700 may be implemented in the BS 102 or in UE 116. This example is for illustration only and other embodiments can be used without departing from the scope of the presence disclosure.

One promising technique for wireless systems, especially in mmWave is joint phase-time arrays (JPTA) as illustrated in FIG. 7A. The output of the RF chain is split into N paths for the N antennas, where each path includes a True-Time-Delay block (τ₁, τ₂, . . . , τ_{N}) followed by a phase shifter (φ₁, φ₂, φ_{N}) before going to the antenna.

FIG. 7B illustrates an example of JPTA beamforming 750 according to embodiments of the present disclosure. For example, JPTA beamforming 750 may be utilized by the gNB 103 of FIG. 1. This example is for illustration only and other embodiments can be used without departing from the scope of the present disclosure.

As a result of this structure and by properly designing the JPTA parameters, e.g., (τ₁, τ₂, . . . , τ_{N}) and (φ₁, φ₂, φ_{N}), different groups of sub-carriers can have different beams pointing in different directions, as illustrated in FIG. 7B. In FIG. 7B, using the JPTA structure, the network (e.g., the network 130) is able to transmit in M different directions (e.g., M beams) using M different subbands, e.g., sub-band i is associated with beam i, wherein, i=0, 1, . . . , M−1. The example, of FIG. 7B, M=4 and the transmission is to 4 different UEs in different directions. In this disclosure a sub-band can refer to any frequency domain region (e.g., sub-carriers, physical resource blocks (PRBs) or sub-channels, wherein a sub-channel is a group of PRBs) in which an SSB can be transmitted.

JPTA is an example, of a multi-antenna system, where the transmitter can simultaneously transmit on different beams in different directions, and/or where the receiver can simultaneously receive on different beams in different directions. Other multi-antenna architectures supporting simultaneous multi-beam transmission and/or reception can be used.

To access the network, a UE (e.g., the UE 116) monitors and receives synchronization signal/physical broadcast channel (PBCH) (SS/PBCH) Blocks, referred to as SSB blocks. This allows the UE to establish time and frequency synchronization with the network and receive information (e.g., in master information block (MIB)) on the PBCH channel to access the network. In NR, up to 8 different SSBs can be transmitted in FR1 and up to 64 different SSBs can be transmitted in FR2. Each SSB can be associated with a quasi-co-location or a beam. The SSBs are time division multiplexed as described in TS 38.213. The SSBs repeat every time period T. For example, T can be 5 ms, 10 ms, 20 ms, 40 ms, 80 ms, or 160 ms. The period T can be configured by higher layers. In one example, a UE initially accessing the network can expect a default period T, for example the default period can be 20 ms.

With analog-based beamforming, a single beam is used at time t, hence the time division multiplexing of the SSBs that can be using different beams. However, if JPTA, or multi-antenna architecture that supports simultaneous transmission of beams, is leveraged, at time t there could be M different sub-bands as illustrated in FIG. 7B, each sub-band can be on different beam. Each sub-band can include a different SSB, hence leveraging time-frequency multiplexing of SSBs.

In this disclosure, aspects related to beam-based time-frequency multiplexing of SSBs are provided.

As mentioned herein, with advanced antenna array systems (e.g., JPTA), at time instant t, different groups of sub-carriers or different groups of PRBs or different sub-bands can be transmitted using different beams as illustrated in FIG. 7A. Alternatively, different beams can be used for a same frequency.

Hence, it is feasible to frequency division multiplex the SSBs in one-time unit. A time-unit for example, can be the time during which an SSB is transmitted. For example, a time-unit can be a symbol, or a group of symbols, or a slot or a group of slots. In one example, an SSB is transmitted in a sub-band or a group of sub-carriers or a group of PRBs with a same beam. In one example, if there are M sub-bands at time t or in a time unit, up to M SSBs can be transmitted in that time unit.

As mentioned herein, SSBs are repeated every period T. One example of mapping SSBs to subbands is to have the SSB mapped to same sub-band every period T as described later in this disclosure. While this provides a simple mapping rule, it limits the transmission of the SSB to same sub-band, this can pose the following challenges:
In a frequency selective channel, the sub-band selected for the SSB transmission on a beam suffers from frequency selective fading.
A reduced capability UE is limited to operating in one sub-band or a limited number of sub-bands, hence it might be unable to monitor and receive SSBs not transmitted in that sub-band.

In the present disclosure, different mapping schemes are provided for SSBs to time-frequency resources and their relation to the SSB used to address the mentioned herein issues.

The present disclosure relates to a 5G/NR and/or 6G communication system.

This disclosure provides aspects related to design mapping of SSBs to beams and sub-bands.

In the following, both frequency division duplexing (FDD) and time division duplexing (TDD) are provided as a duplex method for DL and UL signaling. In addition, full duplex (XDD) operation is possible, e.g., sub-band full duplex (SBFD) or single frequency full duplex (SFFD).

Although exemplary descriptions and embodiments to follow expect orthogonal frequency division multiplexing (OFDM) or orthogonal frequency division multiple access (OFDMA), this disclosure can be extended to other OFDM-based transmission waveforms or multiple access schemes such as filtered OFDM (F-OFDM).

This disclosure provides several components that can be used in conjunction or in combination with one another, or can operate as standalone schemes.

In this disclosure, RRC signaling (e.g., configuration by RRC signaling) includes (1) common signaling, e.g., this can be system information block (SIB)-based RRC signaling (e.g., SIB 1 or other SIB) or (2) RRC dedicated signaling that is sent to a specific UE or (3) UE-group RRC signaling.

In this disclosure MAC CE signaling can be UE-specific e.g., to one UE and can be UE common (e.g., to a group of UEs or to all UEs in a cell). MAC CE signaling can be DL MAC CE signaling or UL MAC CE signaling.

In this disclosure L1 control signaling includes: (1) DL control information (e.g., downlink control information (DCI) on physical downlink control channel (PDCCH) or DL control information on PDSCH) and/or (2) UL control information (e.g., uplink control information (UCI) on physical uplink control channel (PUCCH) or physical uplink shared channel (PUSCH)). L1 control signaling be UE-specific e.g., to one UE and can be UE common (e.g., to a group of UEs or to all UEs in a cell).

In the present disclosure, the term “activation” describes an operation wherein a UE receives and decodes a signal from the network (or gNB) that signifies a starting point in time. The starting point can be a present or a future slot/subframe or symbol and the exact location is either implicitly or explicitly indicated, or is otherwise specified in the system operation or is configured by higher layers. Upon successfully decoding the signal, the UE responds according to an indication provided by the signal. The term “deactivation” describes an operation wherein a UE receives and decodes a signal from the network (or gNB) that signifies a stopping point in time. The stopping point can be a present or a future slot/subframe or symbol and the exact location is either implicitly or explicitly indicated, or is otherwise specified in the system operation or is configured by higher layers. Upon successfully decoding the signal, the UE responds according to an indication provided by the signal.

Terminology such as TCI, TCI states, SpatialRelationInfo, target RS, reference RS, and other terms is used for illustrative purposes and is therefore not normative. Other terms that refer to same functions can also be used.

In this disclosure, the symbol % denotes modulo division, where b % a is the remainder of dividing b by a.

A “reference RS” (e.g., reference source RS) corresponds to a set of characteristics of a DL beam or an UL TX beam, such as a direction, a precoding/beamforming, a number of ports, and so on. For instance, the UE can receive a source RS index/ID in a TCI state assigned to (or associated with) a DL transmission (and/or UL transmission), the UE applies the known characteristics of the source RS to the assigned DL transmission (and/or UL transmission). The source RS can be received and measured by the UE (in this case, the source RS is a downlink measurement signal such as non-zero power (NZP) CSI-RS and/or SSB) with the result of the measurement used for calculating a beam report (e.g., including at least one layer 1 reference signal received power (L1-RSRP)/layer 1 signal-to-interference-plus-noise ratio (L1-SINR) accompanied by at least one CRI or SSB resource indicator (SSBRI)). As the NW/gNB receives the beam report, the NW can be better equipped with information to assign a particular DL (and/or UL) TX beam to the UE. Optionally or alternatively, the source RS can be transmitted by the UE (in this case, the source RS is an uplink measurement signal such as SRS). As the NW/gNB receives the source RS, the NW/gNB can measure and calculate the needed information to assign a particular DL (or/and UL) TX beam to the UE.

In the following examples, a gNB or TRP can transmit N SSBs (or up to N SSBs). In this disclosure, an SSB can refer to SSB index, for example, the N SSBs can be N SSB indices. For example, a bitmap can determine which of N SSBs to transmit. The transmission of N or up to N SSBs is repeated periodically with a period T. In one example, a UE can expect e.g., before accessing the network (e.g., the network 130) and before getting configuration information, that the period of SSBs is a default period T_{d}. In one example, T=T_{d}, in one example, T<T_{d}. In one example, T>T_{d}. Within a time-unit (e.g., a time-unit can correspond to the transmission duration of one SSB), there are M sub-bands. In one example, up to M SSBs are transmitted in one time-unit, e.g., by transmitting one SSB in one sub-band. In one example, each sub-band is associated with a beam or quasi-co-location property for example as illustrated in FIG. 7A. In one example, SSBs are indexed as n=0, 1, . . . N−1. During one period, the SSBs are transmitted in K time-units or K time occasions. In one example, the sub-bands in one time-unit or time occasion are indexed as m=0, 1, . . . , M−1. In one example, the time-units are indexed as: k=0, 1, . . . , K−1. In one example,

$$K = ⌈ \frac{N}{M} ⌉ .$$

In one example, there are B beams corresponding to the N SSBs. In one example, the beam index is given by b=0, 1, . . . , B−1. In one example, B=N. In one example, the SSBs transmitted in one period are referred to as an SSB group. A SSB group can include N SSBs or up to N SSBs.

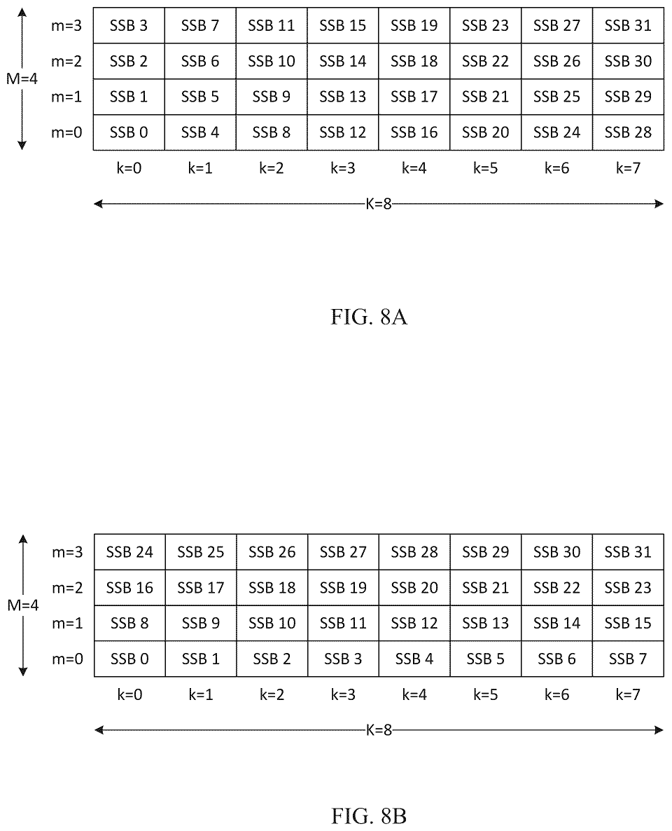

FIGS. 8A and 8B illustrate examples of SSB groups according to embodiments of the present disclosure. The embodiment of the SSB groups illustrated in FIGS. 8A and 8B is for illustration only. However, SSB groups come in a wide variety of configurations and FIGS. 8A and 8B do not limit the scope of this disclosure to any particular implementation of an SSB group.

As shown in FIGS. 8A and 8B, the SSB groups have N SSB indices or simply N SSBs. In the examples of FIGS. 8A and 8B, N=32, the SSB group has M sub-bands or frequency occasions. In the examples of FIGS. 8A and 8B, M=4, for example the frequency occasions can be m=0, . . . , m=3. The SSB group has K time units or time occasions. In the examples of FIGS. 8A and 8B, K=8, the time units or time occasions can be k=0, . . . , k=7. In one example, N≤M·K. In one example, N=M·K. In one example,

$$K = ⌈ \frac{N}{M} ⌉ .$$

In one example, a bitmap (e.g., of size N) can indicate which of the N SSB indices or N SSBs are transmitted.

In one example, the SSB indices are mapped to the time and frequency occasions of an SSB group in the following order: frequency first, time second as illustrated in FIG. 8A. In another example, the SSB indices are mapped to the time and frequency occasions of an SSB group in the following order: time first, frequency second as illustrated in FIG. 8B.

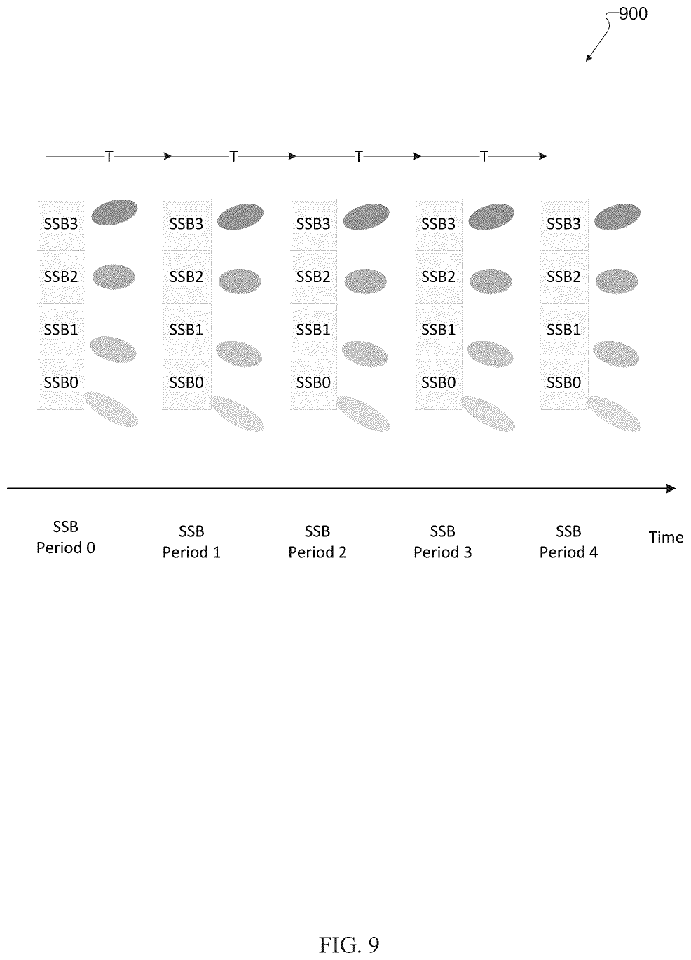

In one example, of this disclosure, the SSB mapping is the same in each SSB group as illustrated in FIG. 9,

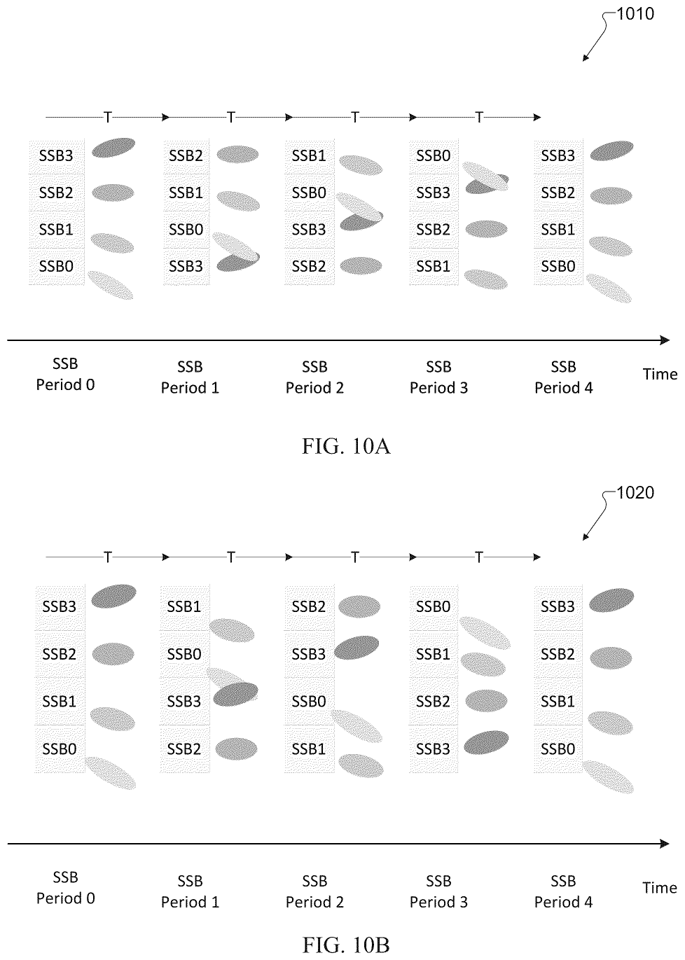

In one example, of this disclosure, the SSB mapping can change between SSB groups as illustrated in FIG. 10A and FIG. 10B.

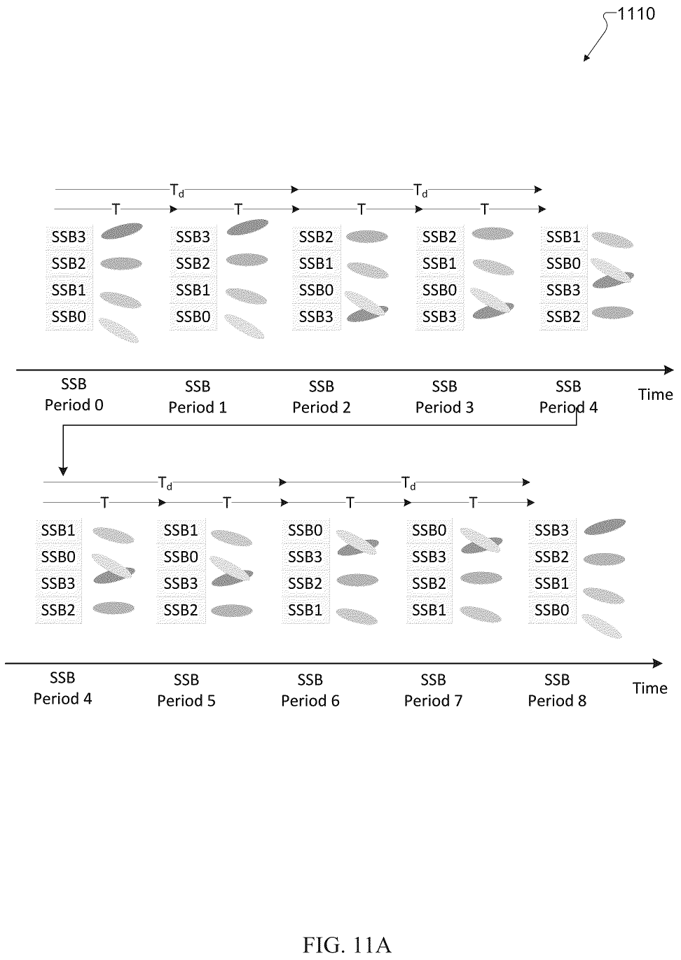

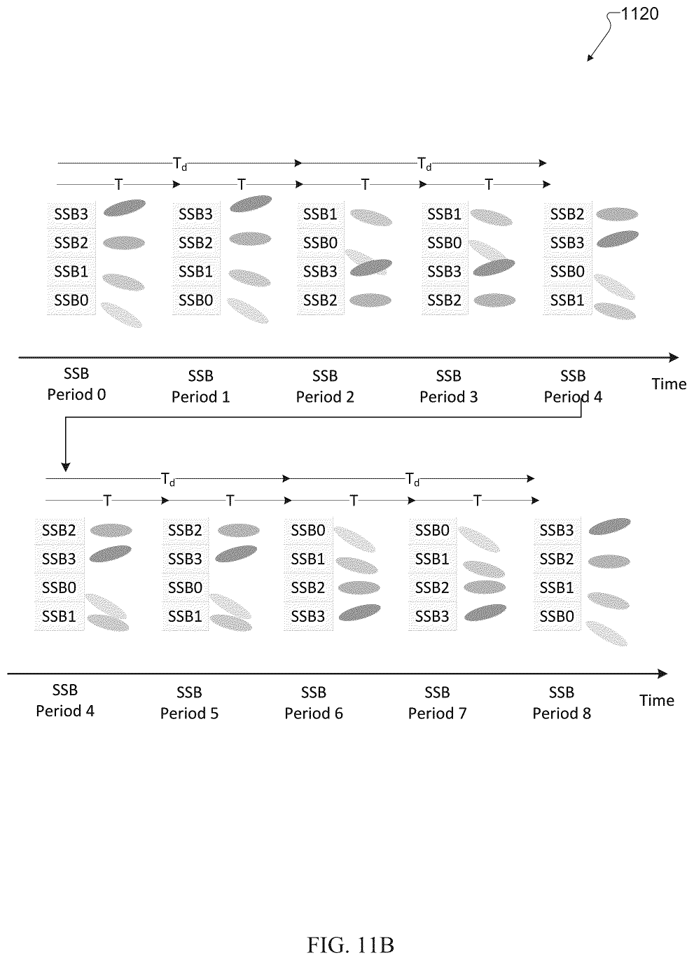

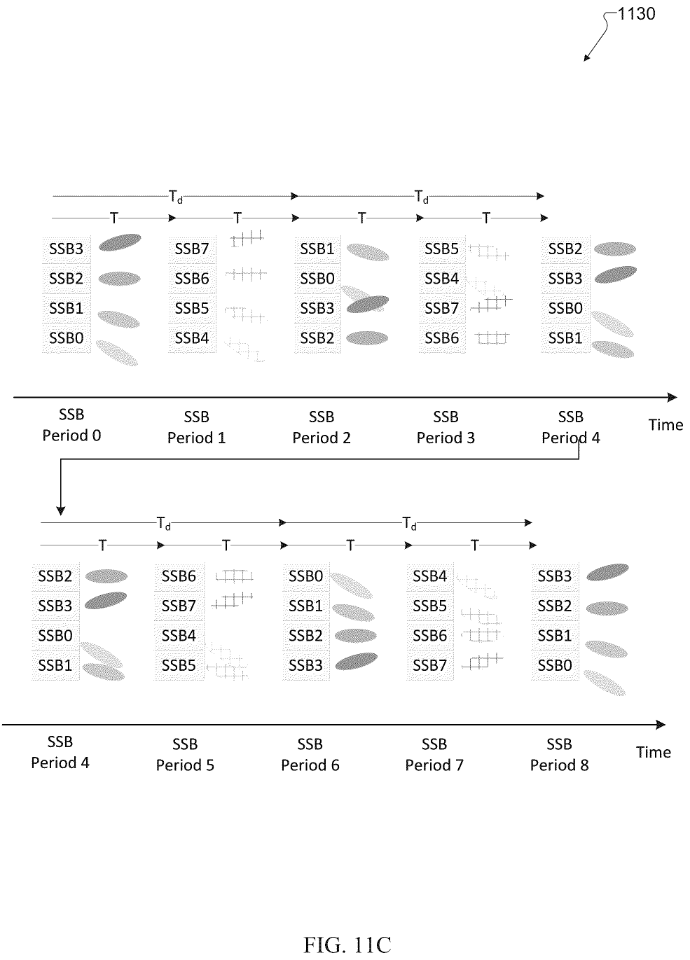

In one example, of this disclosure, the SSB mapping is the same in L consecutive SSB groups, and then changes to different mapping in the next L consecutives SSB groups and so on as illustrated in FIG. 11A and FIG. 11B.

In one example, the M SSBs transmitted at the same time can be contiguous in frequency domain. In one example, the M SSBs transmitted at the same time can be in contiguous sub-bands (or frequency occasions). In one example, the M SSBs transmitted at the same time can be non-contiguous in frequency domain (e.g., have a gap in frequency domain between adjacent SSBs). While the drawings in this document, for convenience, show SSBs contiguous in frequency domain, it is understood that the examples also apply to cases when there is a frequency gap between SSBs. The frequency gap can be uniform or non-uniform.

In one example, a time-unit or time occasion is symbol. In one example, a time-unit or time occasion is a group of symbols. In one example, a time unit or time occasion is a slot. In one example, a time unit or time occasion is an SSB or has a duration of an SSB. In one example, a time-unit or time occasion is a group of slots. In one example, time-units or time occasions (e.g., for SSB transmission) in period T (e.g., SSB group) are consecutive. In one example, time-units or time occasions (e.g., for SSB transmission) in period T (e.g., SSB group) are not consecutive. While the drawings in FIGS. 8A and 8B, for convenience, show SSBs contiguous in time domain in an SSB group, it is understood that the examples also apply to cases when there is a time gap between SSBs in an SSB group. The frequency gap can be uniform or non-uniform.

In one example, each two adjacent sub-bands (or frequency occasions) in a same time unit are separated by P PRBs, or frequency units (e.g., start to start or end to end or center to center or end to start). Each two adjacent SSBs in a same time-unit are separated by P PRBs, or frequency units. In one example, the separation between adjacent bands is uniform (e.g., constant P). In one example, the separation between adjacent bands is non-uniform (e.g., P can be different for each two adjacent sub-bands (or frequency occasions).

FIG. 9 illustrates an example of a timeline 900 for mapping SSBs to beams and sub-bands (or frequency occasions) according to embodiments of the present disclosure. For example, timeline 900 for mapping SSBs to beams and sub-bands (or frequency occasions) can be followed by the gNB 102 of FIG. 1. This example is for illustration only and other embodiments can be used without departing from the scope of the present disclosure.

In one example, the SSB index and the beam index are associated with the same sub-band in SSB periods. The SSB is transmitted in the same beam and same sub-band (or frequency occasion) in each period. In one example as illustrated in FIG. 9, with N=4 and M=4 and K=1. In one example, the SSB index, n, transmitted in sub-band m and time-unit k is given by n=ƒ1(k, m). The beam index, b, used for sub-band m and time-unit k is given by b=ƒ2(k, m). In one example, ƒ1(k, m)=ƒ2(k, m). In one example, ƒ1(k, m)=k*M+m (e.g., mapping frequency first, time second). In one example, ƒ1(k, m)=m*K+k (e.g., mapping time first, frequency second). In one example, ƒ2 (k, m)=k*M+m. In one example, ƒ2 (k, m)=m*K+k.

In one example, for a given SSB index, n, the sub-band, m, is given by m=g1(n), and the time-unit, k, is given by k=h1(n). In one example, for a given beam index, b, the sub-band, m, is given by m=g2(b), and the time-unit, k, is given by k=h2(b). In one example, g1(x)=g2(x). In one example, h1(x)=h2(x). In one example, n=b. In one example, g1(n)=n % M. In one example,

$$g 1 ( n ) = ⌊ \frac{n}{K} ⌋ .$$

In one example, h1(n)=n % K. In one example,

$$h 1 ( n ) = ⌊ \frac{n}{M} ⌋ .$$

In one example, g2(b)=b % M. In one example,

$$g 2 ( b ) = ⌊ \frac{b}{K} ⌋ .$$

In one example, h2(b)=b % K. In one example,

$$h 2 ( b ) = ⌊ \frac{b}{M} ⌋ .$$

In a variant of the example herein, only M1 subbands are used, where M1<M. In the examples herein, M is replaced by M1.

FIGS. 10A and 10B illustrate an example of a timeline 1010 and 1020, respectively, for mapping SSBs to beams and sub-bands (or frequency occasions) according to embodiments of the present disclosure. For example, timeline 1010 and 1020, respectively, for mapping SSBs to beams and sub-bands (or frequency occasions) can be followed by the gNB 102 of FIG. 2. This example is for illustration only and other embodiments can be used without departing from the scope of the present disclosure.

FIGS. 11A, 11B, and 11C illustrate an example of a timeline 1110, 1120, and 1130, respectively, for mapping SSBs to beams and sub-bands (or frequency occasions) according to embodiments of the present disclosure. For example, timeline 1110, 1120, and 1130, respectively, for mapping SSBs to beams and sub-bands (or frequency occasions) can be followed by the gNB 103 of FIG. 1. This example is for illustration only and other embodiments can be used without departing from the scope of the present disclosure.

In one example, the SSB index and the beam index are associated with the different sub-bands (or frequency occasions) in SSB periods or group of SSB periods. In one example, the SSBs in an SSB period can be referred to as SSB group. The SSB is transmitted in the same beam but in a different sub-band (or frequency occasion) in each period T₂. The beams in one time-unit (or one period) change each period T₂. In one example, the SSB index and the beam index are the same. In one example, T₂=T. In one example, T₂=max(T, T_{d}). In one example, T₂=T_{d}. In one example, the SSB and the beam cycle through the sub-bands (or frequency occasions) changing every period T₂. In one example as illustrated in FIG. 10A, with N=4 and M=4 and K=1, the SSB changes sub-bands every period T. In one example as illustrated in FIG. 11A, with N=4 and M=4 and K=1, the SSB changes sub-bands every period T_{d}, with T_{d}=2T.

In one example, let τ be an index of a period T₂. In one example, if t is the time at the start of the period T₂, for example relative to start of frame 0, or a system frame number (SFN) roll-over, the period index can be given by

$$τ = ⌊ \frac{t}{{T}_{2}} ⌋ .$$

In one example, τ is in the range 0, 1, . . . , M−1. In one example,

$$τ = ⌊ \frac{t}{{T}_{2}} ⌋ \% M .$$

In one example, τ is related to or determines an SSB group index s, e.g., s=τ.

In one example, the SSB index, n, transmitted in sub-band m and time-unit k is given by n=ƒ1(k, m, τ). The beam index, b, used for sub-band m and time-unit k is given by b=ƒ2(k, m, τ). In one example, ƒ1(k, m, τ)=ƒ2(k, m, τ). In one example, ƒ1(k, m, τ)=k*M+(m+ƒ3(τ))% M (e.g., mapping frequency first with hopping, time second). In one example, ƒ1(k, m, τ)=((m+ƒ3(τ))% M)*K+k (e.g., mapping time first, frequency second with hopping for frequency). In one example, ƒ2 (k, m, τ)=k*M+(m+ƒ4(τ))% M. In one example, ƒ2(k, m, τ)=((m+ƒ4(τ))% M)*K+k. In one example, ƒ3(τ)=ƒ4(τ). In one example, ƒ3(τ)=τ. In one example, ƒ3(τ)=−τ. In one example, ƒ3(τ)=M−τ.

In one example, for a given SSB index, n, the sub-band, m, is given by m=g1(n, τ), and the time-unit, k, is given by k=h1(n) (e.g., the time-unit is the same across SSB groups). In a variant example, the time-unit index can depend on the SSB group index or time index (τ), e.g., k=h1(n, τ). In one example, for a given beam index, b, the sub-band, m, is given by m=g2(b, τ), and the time-unit, k, is given by k=h2(b) (e.g., the time-unit is the same across SSB groups). In a variant example, the time-unit index can depend on the SSB group index or time index (τ), e.g., k=h2(b, τ). In one example, g1(x, τ)=g2(x, τ). In one example, h1(x)=h2(x). In one example, h1(x, τ)=h2(x, τ). In one example, n=b. In one example, g1(n, τ)=(n+ƒ3(τ))% M. In one example,

$$g 1 ( n , τ ) = ( ⌊ \frac{n}{K} ⌋ + f 3 ( τ ) ) \% M .$$

In one example, h1(n)=n % K. In one example,

$$h 1 ( n ) = ⌊ \frac{n}{M} ⌋ .$$

In one example, g2(b)=(b+ƒ4(τ))% M. In one example,

$$g 2 ( b ) = ( ⌊ \frac{b}{K} ⌋ + f 4 ( τ ) ) \% M .$$

In one example, h2(b)=b % K. In one example,

$$h 2 ( b ) = ⌊ \frac{b}{M} ⌋ .$$

In one example, ƒ3(τ)=ƒ4(τ). In one example, ƒ3(τ)=τ. In one example, ƒ3(τ)=−τ. In one example, ƒ3(τ)=M−τ. In one example, ƒ3(τ)=τ% M. In one example, ƒ3(τ)=(−τ)% M. In one example, ƒ3(τ)=(M−τ)% M. In one example, the function ƒ3(τ) is given by ƒ(τ) of Table 1.

TABLE 1
Examples of function f (τ) for different values of M

| | f (τ) | | | | | | | |
|---|---|---|---|---|---|---|---|---|
| τ % M | M = 1 | M = 2 | M = 3 | M = 4 | M = 6 | M = 8 | M = 12 | M = 16 |
| 0 | 0 | 0 | 0 | 0 | 0 | 0 | 0 | 0 |
| 1 | | 1 | 1 | 2 | 3 | 4 | 6 | 8 |
| 2 | | | 2 | 1 | 1 | 2 | 3 | 4 |
| 3 | | | | 3 | 4 | 6 | 9 | 12 |
| 4 | | | | | 2 | 1 | 1 | 2 |
| 5 | | | | | 5 | 5 | 7 | 10 |
| 6 | | | | | | 3 | 4 | 6 |
| 7 | | | | | | 7 | 10 | 14 |
| 8 | | | | | | | 2 | 1 |
| 9 | | | | | | | 8 | 9 |
| 10 | | | | | | | 5 | 5 |
| 11 | | | | | | | 11 | 13 |
| 12 | | | | | | | | 3 |
| 13 | | | | | | | | 11 |
| 14 | | | | | | | | 7 |
| 15 | | | | | | | | 15 |

In one example, if the time index i is in the range from 0 to M−1, e.g., τ is a counter that gets reset each M SSB transmissions for an SSB index, or each M SSB groups, or each L·M SSB groups, where L is the number of SSB groups using a same sub-band or frequency occasion for an SSB index. Let τᵣ be the reverse binary representation of τ, expecting ┌log₂ M┐ bits. For example, if M=4, τ can be 00, 01, 10 and 11 in binary representation. The reverse binary representation is 00, 10, 01, and 11 respectively. In one example, function ƒ1(k, m, τ)=k*M+m⊗τᵣ. Where, ⊗ is a bitwise XOR operator. For example, 00⊗10=10, 11⊗10=01 and 10⊗10=00 and 01⊗10=11. FIG. 10B, illustrates an example of such mapping with M=4 and N=4 and K=1.

In one example, with this mapping, if a user supports 1 SSB decode at a time, and one of the sub-bands is selected (e.g., the lower sub-band), the UE cycles through 4 SSBs in order 0, 2, 1, 3 in 4 periods. In one example, with this mapping, if a user supports 2 SSB decodes at a time, and two of the sub-bands are selected (e.g., the two lower sub-bands, the UE cycles through 4 SSBs in order (0,1), (2,3) in 2 periods, the next two periods also have (0,1), (2,3), but in reverse frequency order. Similarly, if the two upper sub-bands are selected, the UE cycles through 4 SSBs in order (2,3), (0,1) in 2 periods. In one example, a pattern is selected for the hopping of the SSBs and beams across frequency bands (or frequency occasion), such that if a smaller number of sub-bands (or frequency occasions) is used (e.g., due to UE capability or configuration), a minimum number of periods is used to cycle through the SSBs and beams.

In a variant example of FIG. 10B, each SSB is repeated in the same sub-band L times, before moving the next sub-band as illustrated in FIG. 11B with L=2.

In FIG. 11C, N=8 and M=4, L=1. In this example, the SSB indices are spread across two SSB periods of duration T, for example, in even SSB periods, the SSB group includes SSB indices 0, 1, 2 and 3; and in odd SSB periods the SSB group includes SSB indices 4, 5, 6 and 7. In a variant example, the SSB group can be considered as two consecutive SSB periods, with 8 SSB indices (0, . . . 7), for example, the first SSB period of the two consecutive SSB periods can be considered to have k=0, and the second SSB period of the two consecutive SSB periods can be considered to have k=1, and the SSB group period is 2T=T_{d}, in the example of FIG. 11C.

In a variant of the example herein, only M1 subbands are used, where M1≤M. In the examples herein, M is replaced by M1.

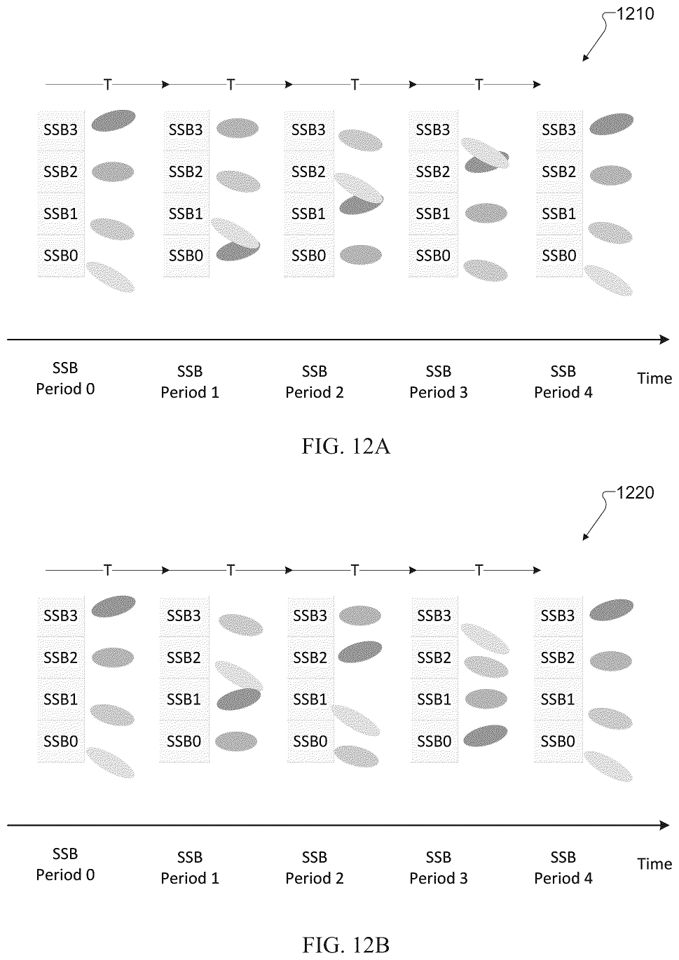

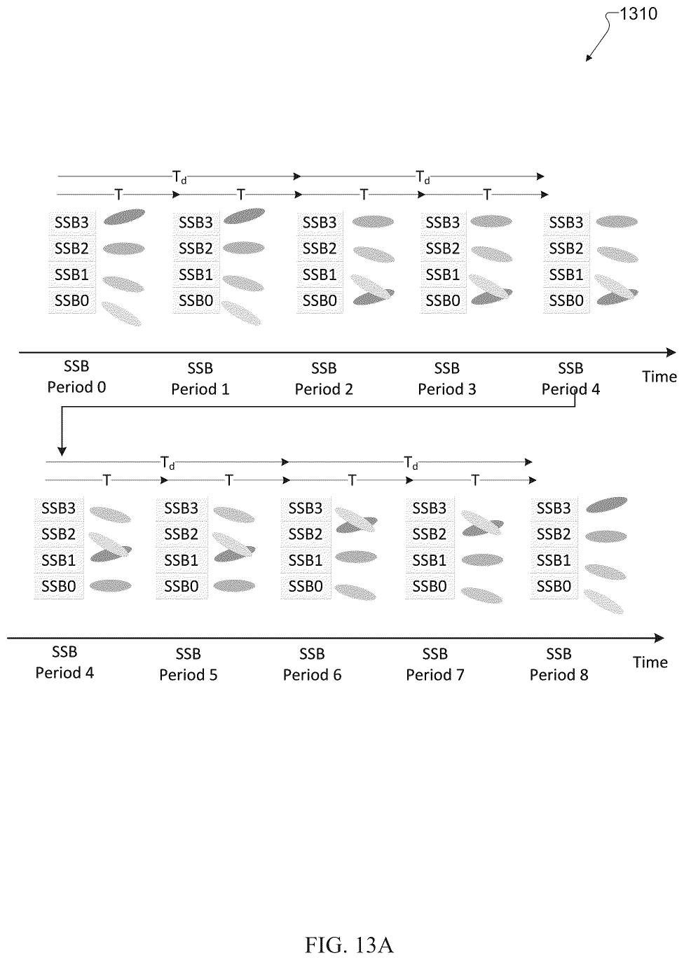

FIGS. 12A and 12B illustrate an example of a timeline 1210 and 1220, respectively, for mapping SSBs to beams and sub-bands (or frequency occasions) according to embodiments of the present disclosure. For example, timeline 1210 and 1220, respectively, for mapping SSBs to beams and sub-bands (or frequency occasions) can be followed by the gNB 102 of FIG. 2. This example is for illustration only and other embodiments can be used without departing from the scope of the present disclosure.

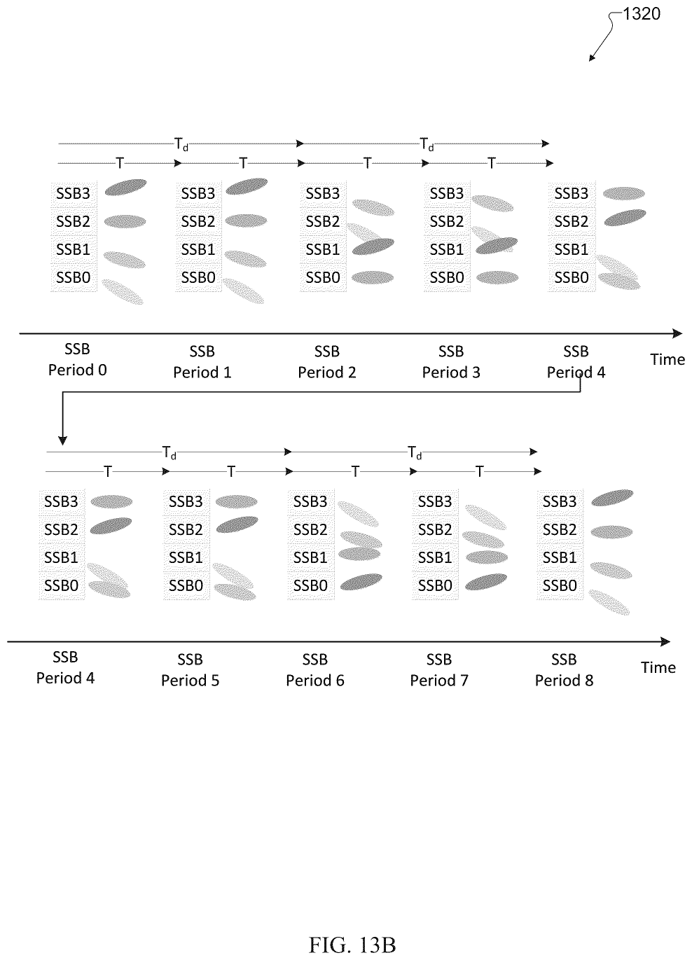

FIGS. 13A and 13B illustrate an example of a timeline 1310 and 1320, respectively, for mapping SSBs to beams and sub-bands (or frequency occasions) according to embodiments of the present disclosure. For example, timeline 1310 and 1320, respectively, for mapping SSBs to beams and sub-bands (or frequency occasions) can be followed by the gNB 103 of FIG. 1. This example is for illustration only and other embodiments can be used without departing from the scope of the present disclosure.

In one example, the SSB index is associated with the same sub-band (or frequency occasions) in SSB periods, and the beam index is associated with the different sub-bands (or frequency occasions) in SSB periods or group of SSB periods. In one example, the SSBs in an SSB period can be referred to as SSB group. The SSB is transmitted in the same sub-band (or frequency occasion) but in a different beam in each period T₂. The beams in one time-unit (or one period) change each period T₂. In one example, T₂=T. In one example, T₂=max(T, T_{d}). In one example, T₂=T_{d}. In one example, the beam cycles through the sub-bands (or frequency occasions) changing every period T₂. In one example as illustrated in FIG. 12A, with N=4 and M=4 and K=1, the beam changes sub-bands every period T. In one example as illustrated in FIG. 13A, with N=4 and M=4 and K=1, the beam changes sub-bands every period T_{d}, with T_{d}=2T.

In one example, let τ be an index of a period T₂. In one example, if t is the time at the start of the period T₂, for example relative to start of frame 0, or a SFN roll-over, the period index can be given by

$$τ = ⌊ \frac{t}{{T}_{2}} ⌋ .$$

In one example, τ is in the range 0, 1, . . . , M−1. In one example,

$$τ = ⌊ \frac{t}{{T}_{2}} ⌋ \% M .$$

In one example, τ is related to or determines an SSB group index s, e.g., s=τ.

In one example, the SSB index, n, transmitted in sub-band m and time-unit k is given by n=ƒ1(k, m). The beam index, b, used for sub-band m and time-unit k is given by b=ƒ2(k, m, τ). In one example, ƒ1(k, m)=ƒ2(k, m, τ=0). In one example, ƒ1(k, m)=k*M+m (e.g., mapping frequency first, time second). In one example, ƒ1(k, m)=m*K+k (e.g., mapping time first, frequency second). In one example, ƒ2 (k, m, τ)=k*M+(m+ƒ4(τ))% M. In one example, ƒ2 (k, m, τ)=((m+ƒ4(τ))% M)*K+k. In one example, ƒ4(τ)=τ. In one example, ƒ4(τ)=−τ. In one example, ƒ4(τ)=M−τ.

In one example, for a given SSB index, n, the sub-band, m, is given by m=g1(n), and the time-unit, k, is given by k=h1(n). In one example, for a given beam index, b, the sub-band, m, is given by m=g2(b, τ), and the time-unit, k, is given by k=h2(b) (e.g., the time-unit is the same across SSB groups). In a variant example, the time-unit index can depend on the SSB group index or time index (τ), e.g., k=h2(b, τ). In one example, g1(x)=g2(x, τ=0). In one example, h1(x)=h2(x). In one example, h1(x)=h2(x, τ=0). In one example, n=b, e.g., if τ=0. In one example, g1(n)=n % M. In one example,

$$g 1 ( n ) = ⌊ \frac{n}{K} ⌋ \% M .$$

In one example,

$$h 1 ( n ) = ⌊ \frac{n}{M} ⌋ .$$

In one example, h1(n)=n % K. In one example

$$g 1 ( n ) = ⌊ \frac{n}{K} ⌋ .$$

In one example, g2(b)=(b+ƒ4(τ))% M. In one example,

$$g 2 ( b ) = ( ⌊ \frac{b}{K} ⌋ + f 4 ( τ ) ) \% M .$$

In one example, h2(b)=b % K. In one example,

$$h 2 ( b ) = ⌊ \frac{b}{M} ⌋ .$$

In one example, ƒ4(τ)=τ. In one example, ƒ4(τ)=−τ. In one example, ƒ4(τ)=M−τ. In one example, ƒ4(τ)=τ% M. In one example, ƒ4(τ)=(−τ)% M. In one example, ƒ4(τ)=(M−τ)% M. In one example, the function ƒ4(τ) is given by ƒ(τ) of Table 1.

Similar to one or more examples described herein, the reverse binary representation of counter τ, i.e., τᵣ with a bitwise XOR operator with m to determine the beam index for each transmission instance as illustrated in FIG. 12B with M=4 and N=4 and K=1. In one example, a pattern is selected for the hopping of the beams across frequency bands (or frequency occasions), such that if a smaller number of sub-bands (or frequency occasions) is used (e.g., due to UE capability or configuration), a minimum number of periods (or SSB groups) is used to cycle through the beams. Similarly, each beam for an SSB index transmission is used L times before switching to the next beam as illustrate in FIG. 13B, with =4 and N=4 and K=1 and L=2.

In a variant of the example herein, only M1 subbands are used, where M1≤M. In the examples herein, M is replaced by M1.

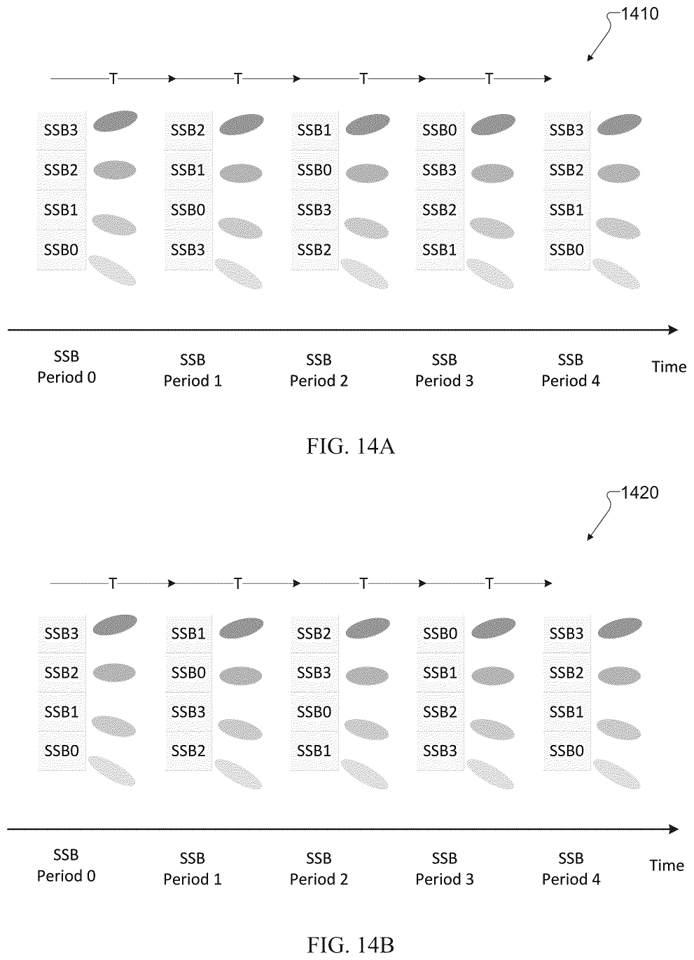

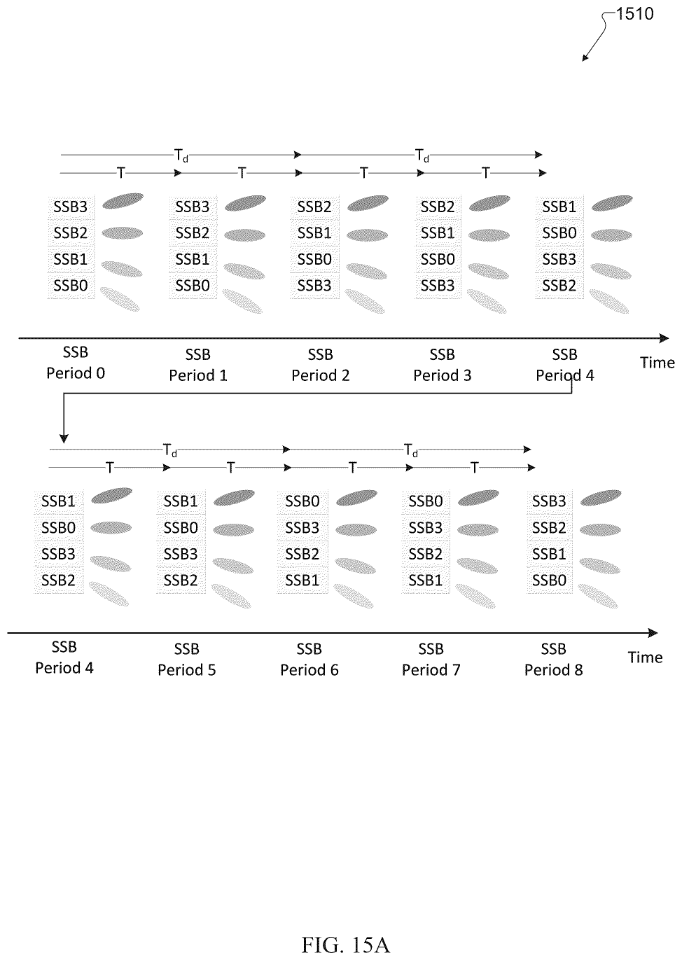

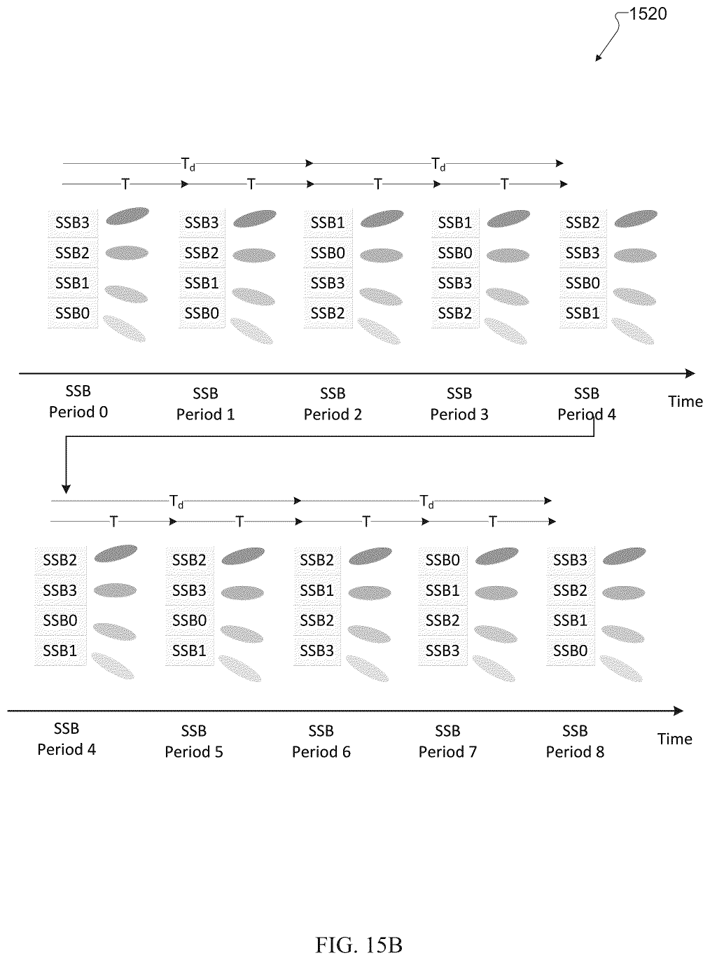

In one example, the beam index is associated with the same sub-band (or frequency occasion) in SSB periods, and the SSB index is associated with the different sub-bands (or frequency occasions) in SSB periods or group of SSB periods. In one example, the SSBs in an SSB period can be referred to as SSB group. The SSB is transmitted in a different sub-band (or frequency occasion) and in a different beam in each period T₂. The beams in one time-unit (or one period) are the same for each sub-band. In one example, T₂=T. In one example, T₂=max(T, T_{d}). In one example, T₂=T_{d}. In one example, the SSB cycles through the sub-bands (or frequency occasions) changing every period T₂. In one example as illustrated in FIG. 14A, with N=4 and M=4 and K=1, the beam changes sub-bands every period T. In one example as illustrated in FIG. 15A, with N=4 and M=4 and K=1, the beam changes sub-bands every period T_{d}, with T_{d}=2T.

In one example, let τ be an index of a period T₂. In one example, if t is the time at the start of the period T₂, for example relative to start of frame 0, or a SFN roll-over, the period index can be given by

$$τ = ⌊ \frac{t}{{T}_{2}} ⌋ .$$

In one example, τ is in the range 0, 1, . . . , M−1. In one example,

$$τ = ⌊ \frac{t}{{T}_{2}} ⌋ \% M .$$

In one example, τ is related to or determines an SSB group index s, e.g., s=τ.

In one example, the SSB index, n, transmitted in sub-band m and time-unit k is given by n=ƒ1(k, m, τ). The beam index, b, used for sub-band m and time-unit k is given by b=ƒ2(k, m). In one example, ƒ1(k, m, τ=0)=ƒ2(k, m). In one example, ƒ1(k, m, τ)=k*M+(m+ƒ3(τ))% M (e.g., mapping frequency first with hopping, time second). In one example, ƒ1(k, m, τ)=((m+ƒ3(τ))% M)*K+k (e.g., mapping time first, frequency second with hopping for frequency). In one example, ƒ2(k, m)=k*M+m. In one example, ƒ2(k, m)=m*K+k. In one example, ƒ3(τ)=τ. In one example, ƒ3(τ)=−τ. In one example, ƒ3(τ)=M−τ.

In one example, for a given SSB index, n, the sub-band, m, is given by m=g1(n, τ), and the time-unit, k, is given by k=h1(n) (e.g., the time-unit is the same across SSB groups). In a variant example, the time-unit index can depend on the SSB group index or time index (τ), e.g., k=h1(n, τ). In one example, for a given beam index, b, the sub-band, m, is given by m=g2(b), and the time-unit, k, is given by k=h2(b). In one example, g1(x, τ=0)=g2(x). In one example, h1(x)=h2(x). In one example, h1(x, τ=0)=h2(x). In one example, n=b, e.g., if τ=0. In one example, g1(n, τ)=(n+ƒ3(τ))% M. In one example,

$$g 1 ( n , τ ) = ( ⌊ \frac{n}{K} ⌋ + f 3 ( τ ) ) \% M .$$

In one example, h1(n)=n % K. In one example,

$$h 1 ( n ) = ⌊ \frac{n}{M} ⌋ .$$

In one example, g2(b)=b=b % M. In one example,

$$g 2 ( b ) = ⌊ \frac{b}{K} ⌋ .$$

In one example, h2(b)=b % K. In one example,

$$h 2 ( b ) = ⌊ \frac{b}{M} ⌋ .$$

In one example, ƒ3(τ)=τ. In one example, ƒ3(τ)=−τ. In one example, ƒ3(τ)=M−τ. In one example, ƒ3(τ)=τ% M. In one example, ƒ3(τ)=(−τ)% M. In one example, ƒ3(τ)=(M−τ)% M. In one example, the function ƒ3(τ) is given by ƒ(τ) of Table 1.

FIGS. 14A and 14B illustrate an example of a timeline 1410 and 1420, respectively, for mapping SSBs to beams and sub-bands (or frequency occasions) according to embodiments of the present disclosure. For example, timeline 1410 and 1420, respectively, for mapping SSBs to beams and sub-bands (or frequency occasions) can be followed by the gNB 102 of FIG. 2. This example is for illustration only and other embodiments can be used without departing from the scope of the present disclosure.

FIGS. 15A and 15B illustrate an example of a timeline 1510 and 1520, respectively, for mapping SSBs to beams and sub-bands (or frequency occasions) according to embodiments of the present disclosure. For example, timeline 1510 and 1520, respectively, for mapping SSBs to beams and sub-bands (or frequency occasions) can be followed by the gNB 102 of FIG. 2. This example is for illustration only and other embodiments can be used without departing from the scope of the present disclosure.

Similar to one or more examples described herein, the reverse binary representation of counter τ, i.e., τᵣ with a bitwise XOR operator with m to determine the SSB for each transmission instance as illustrated in FIG. 14B with M=4 and N=4 and K=1. In one example, a pattern is selected for the hopping of the SSBs across frequency bands (or frequency occasions), such that if a smaller number of sub-bands (or frequency occasions) is used (e.g., due to UE capability or configuration), a minimum number of periods (or SSB groups) is used to cycle through the SSBs. Similarly, each SSB index transmission is used L times before switching to the next SSB as illustrated in FIG. 15B, with =4 and N=4 and K=1 and L=2.

In a variant of the example herein, only M1 subbands are used, where M1≤M. In the examples herein, M is replaced by M1.

In one example, the gNB (e.g., the BS 102) transmits the SSBs in more than one sub-band (or frequency occasion), as in the examples mentioned herein, the UE searches and receives the SSBs in more than one sub-band (or frequency occasion). For example, this can be based on a UE capability.

In one example, the gNB transmits the SSBs in more than one sub-band (or frequency occasion), as in the examples mentioned herein, the UE searches and receives the SSBs in one sub-band (or frequency occasion). For example, this can be based on a UE capability.

In one example, the gNB transmits the SSBs in more than one sub-band (or frequency occasion), as in the examples mentioned herein, the UE searches and receives the SSBs in one sub-band (or frequency occasion), wherein the sub-band (or frequency occasion) is the same overtime. For example, this can be based on a UE capability.

In one example, the gNB transmits the SSBs in more than one sub-band (or frequency occasion), as in the examples mentioned herein, the UE searches and receives the SSBs in one sub-band (or frequency occasion), wherein the sub-band (or frequency occasion) can change overtime, for example based on a hopping pattern. For example, this can be based on a UE capability. For example, this can change every period Tₕ. In one example, Tₕ=T. In one example Tₕ=IT, where I is in an integer that can be specified in the system specifications and/or configured or updated by higher layer signaling (e.g., RRC or MAC CE) and/or L1 control (e.g., DCI Format) signaling. In one example, Tₕ=T_{d}. In one example Tₕ=IT_{d}, where I is in an integer that can be specified in the system specifications and/or configured or updated by higher layer signaling (e.g., RRC or MAC CE) or L1 control (e.g., DCI Format) signaling. In one example, let τ be an index of a period Tₕ. In one example, if t is the time at the start of the period Tₕ, for example relative to start of frame 0, or a SFN roll-over or a time (e.g., reference time) selected or determined by the UE, the period index can be given by

$$τ = ⌊ \frac{t}{{T}_{h}} ⌋ .$$

In one example, τ is in the range 0, 1, . . . , M−1. In one example,

$$τ = ⌊ \frac{t}{{T}_{h}} ⌋ \% M .$$

In one example, τ is related to or determines an SSB group index s, e.g. s=τ. In one example, M can be the number of sub-bands (or frequency occasions) as mentioned herein, and/or a value that is specified in the system specifications and/or configured or updated by higher layer signaling (e.g., RRC or MAC CE) and/or L1 control (e.g., DCI Format) signaling. In one example, the frequency of the SSB (e.g., start of the SSB or center of the SSB or end of the SSB) is given by ƒ=ƒ_{c}+Δƒ(τ). In another example, ƒ=ƒ_{c}−Δƒ(τ). In one example, ƒ_{ƒ} is the frequency of the SSB in the lowest sub-band (or frequency occasion). In one example, ƒ_{c} is the frequency of the SSB in the highest sub-band (or frequency occasion). In one example, Δ is a frequency difference between two adjacent sub-bands (or frequency occasions). In one example, ƒ(τ)=τ. In one example, ƒ(τ)=−τ. In one example, ƒ(τ)=M−τ. In one example, ƒ(τ)=τ% M. In one example, ƒ(τ)=(−τ)% M. In one example, ƒ(τ)=(M−τ)% M. In one example, the function ƒ(τ) is given by ƒ(τ) of Table 1. In one example, ƒ_{c} and/or Δ are specified in the system specifications and/or configured or updated by higher layer signaling (e.g., RRC or MAC CE) and/or L1 control (e.g., DCI Format) signaling.

In one example, the gNB transmits the SSBs in more than one sub-band (or frequency occasion), as in the examples mentioned herein, the UE (e.g., the UE 116) searches and receives the SSBs in a subset of the sub-bands (or frequency occasions) transmitted by the gNB. For example, this can be based on a UE capability.

In one example, the gNB transmits the SSBs in more than one sub-band (or frequency occasion), as in the examples mentioned herein, the UE searches and receives the SSBs in a subset of the sub-bands (or frequency occasions) transmitted by the gNB, wherein the subset of sub-bands (or frequency occasions) is the same overtime. For example, this can be based on a UE capability.

In one example, the gNB transmits the SSBs in more than one sub-band (or frequency occasion), as in the examples mentioned herein, the UE searches and receives the SSBs in a subset of the sub-bands (or frequency occasions) transmitted by the gNB, wherein the subset of sub-bands (or frequency occasions) can change overtime, for example based on a hopping pattern, as mentioned herein. For example, this can be based on a UE capability.

In one example, the gNB transmits the SSBs in more than one sub-band (or frequency occasion), as in the examples mentioned herein, the UE searches and receives the SSBs in one sub-band (or frequency occasion). After the UE receives the SSB in the sub-band (or frequency occasion) and associated system information the UE can be informed of additional sub-bands or frequency locations/occasions in which the SSBs are being transmitted and the UE can search and receive the SSBs on the additional sub-bands (or frequency occasions) or a subset of them depending the UE capability and on whether the UE applies a hoping pattern. In one example, the frequency of the first SSB received is determined by the frequency of the carrier.

In one example, the frequencies of the M sub-bands (or frequency occasions) is given by the frequencies of M synchronization (or SSB) raster. In one example, the M synchronization raster correspond to M Global Sync Channel Number (GSCN).

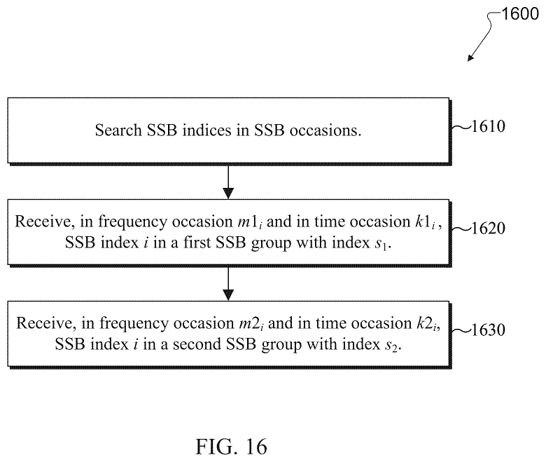

FIG. 16 illustrates an example method 1600 performed by a UE in a wireless communication system according to embodiments of the present disclosure. The method 1600 of FIG. 16 can be performed by any of the UEs 111-116 of FIG. 1, such as the UE 116 of FIG. 3, and a corresponding method can be performed by any of the BSs 101-103 of FIG. 1, such as BS 102 of FIG. 2. The method 1600 is for illustration only and other embodiments can be used without departing from the scope of the present disclosure.

The method 1600 begins with the UE searching SSB indices in SSB occasions (corresponding to sub-band/frequency occasions and time occasions) (1610). For example, in 1610, the SSB occasions are organized in SSB groups, an SSB group of the SSB groups includes N SSB indices in N SSB occasions, and the SSB group spans M sub-bands (or frequency occasions) and K time occasions, where N≤M·K, and M>1.

In some examples, in searching the SSB indices in the SSB occasions, the UE searches all frequency occasions and all time occasions in the SSB group. In some examples, in searching the SSB indices in the SSB occasions, the UE searches one frequency occasion and all time occasions in the SSB group and the searched frequency occasion has a same frequency across SSB groups. In some examples, in searching the SSB indices in the SSB occasions, the UE searches one frequency occasion and all time occasions in the SSB group and the searched frequency occasion follows a hopping pattern across the SSB groups.

The UE receives, in frequency occasion m1ᵢ and in time occasion k1ᵢ, SSB index i in a first SSB group with index s₁ (or corresponding to time τ₁) (1620) and receives, in frequency occasion m2ᵢ and in time occasion k2ᵢ, SSB index i in a second SSB group with index s₂ (1630) (or corresponding to time τ₂). For example, the receptions in 1620 and 1630 may occur as result of or be part of the searching in 1610. In various embodiments, the frequency occasions are different (i.e., m1ᵢ≠m2ᵢ). In some embodiments, the time occasions are the same (i.e., k1ᵢ=k2ᵢ).

In various embodiments, the UE receives, in frequency occasion m3ᵢ and in time occasion k3ᵢ, SSB index i in a third SSB group with index s₃. Here,

$$⌊ \frac{{s}_{1}}{L} ⌋ = ⌊ \frac{{s}_{3}}{L} ⌋ ,$$

where L>1, m3ᵢ=m1ᵢ and k3ᵢ=k1ᵢ. In various embodiments, the UE receives N SSB indices in one frequency occasion across M SSB groups. In various embodiments, the UE receives N SSB indices in M1 consecutive or non-consecutive frequency occasions cycled across

$$⌈ \frac{M}{M 1} ⌉$$

SSB groups.

The above flowchart(s) illustrate example methods that can be implemented in accordance with the principles of the present disclosure and various changes could be made to the methods illustrated in the flowcharts herein. For example, while shown as a series of steps, various steps in each figure could overlap, occur in parallel, occur in a different order, or occur multiple times. In another example, steps may be omitted or replaced by other steps.

Although the figures illustrate different examples of user equipment, various changes may be made to the figures. For example, the user equipment can include any number of each component in any suitable arrangement. In general, the figures do not limit the scope of the present disclosure to any particular configuration(s). Moreover, while figures illustrate operational environments in which various user equipment features disclosed in this patent document can be used, these features can be used in any other suitable system.

Although the present disclosure has been described with exemplary embodiments, various changes and modifications may be suggested to one skilled in the art. It is intended that the present disclosure encompass such changes and modifications as fall within the scope of the appended claims. None of the descriptions in this application should be read as implying that any particular element, step, or function is an essential element that must be included in the claims scope. The scope of patented subject matter is defined by the claims.

What is claimed is:

1. A user equipment (UE), comprising:
a processor configured to search synchronization signal (SS)/physical broadcast channel (PBCH) block (SSB) indices in SSB occasions, wherein:
the SSB occasions are organized in SSB groups,
an SSB group of the SSB groups includes N SSB indices in N SSB occasions, and
the SSB group spans M frequency occasions and K time occasions, where N≤M·K, and M>1; and
a transceiver operably coupled to the processor, the transceiver configured to:
receive, in frequency occasion m1ᵢ and in time occasion k1ᵢ, SSB index i in a first SSB group with index s₁, and
receive, in frequency occasion m2ᵢ and in time occasion k2ᵢ, SSB index i in a second SSB group with index s₂,
wherein m1ᵢ≠m2ᵢ.

2. The UE of claim 1, wherein k1ᵢ=k2ᵢ.

3. The UE of claim 1, wherein:
the transceiver is further configured to receive, in frequency occasion m3ᵢ and in time occasion k3ᵢ, SSB index i in a third SSB group with index s₃,
$$⌊ \frac{{s}_{1}}{L} ⌋ = ⌊ \frac{{s}_{3}}{L} ⌋ ,$$
where L>1,
m3ᵢ=m1ᵢ and
k3ᵢ=k1ᵢ.

4. The UE of claim 1, wherein the transceiver is further configured to receive N SSB indices in one frequency occasion across M SSB groups.

5. The UE of claim 1, wherein the transceiver is further configured to receive N SSB indices in M1 frequency occasions cycled across
$$⌈ \frac{M}{M 1} ⌉$$
SSB groups.

6. The UE of claim 1, wherein to search the SSB indices in the SSB occasions, the processor is further configured to search all frequency occasions and all time occasions in the SSB group.

7. The UE of claim 1, wherein:
to search the SSB indices in the SSB occasions, the processor is further configured to search one frequency occasion and all time occasions in the SSB group, and
the searched frequency occasion has a same frequency across SSB groups.

8. The UE of claim 1, wherein:
to search the SSB indices in the SSB occasions, the processor is further configured to search one frequency occasion and all time occasions in the SSB group, and
the searched frequency occasion follows a hopping pattern across the SSB groups.

9. A base station (BS), comprising:
a processor; and
a transceiver operably coupled to the processor, the transceiver configured to transmit synchronization signal (SS)/physical broadcast channel (PBCH) block (SSB) indices in SSB occasions, wherein:
the SSB occasions are organized in SSB groups,
an SSB group of the SSB groups includes N SSB indices in N SSB occasions,
the SSB group spans M frequency occasions and K time occasions, where N≤M·K, and M>1,
SSB index i, in a first SSB group with index s₁, is transmitted in frequency occasion m1ᵢ and in time occasion k1ᵢ,
SSB index i, in a second SSB group with index s₂, is transmitted in frequency occasion m2ᵢ and in time occasion k2ᵢ, and
m1ᵢ≠m2ᵢ.

10. The BS of claim 9, wherein k1ᵢ=k2ᵢ.

11. The BS of claim 9, wherein:
SSB index i, in a third SSB group with index s₃, is transmitted in frequency occasion m3ᵢ and in time occasion k3ᵢ, and
if
$$⌊ \frac{{s}_{1}}{L} ⌋ = ⌊ \frac{{s}_{3}}{L} ⌋ ,$$
where L>1:
m3ᵢ=m1ᵢ and
k3ᵢ=k1ᵢ.

12. The BS of claim 9, wherein the N SSB indices are transmitted in one frequency occasion across M SSB groups.

13. The BS of claim 9, wherein the N SSB indices are transmitted in M1 frequency occasions across
$$⌈ \frac{M}{M 1} ⌉$$
SSB groups.

14. A method of operating a user equipment (UE), the method comprising:
searching synchronization signal (SS)/physical broadcast channel (PBCH) block (SSB) indices in SSB occasions, wherein:
the SSB occasions are organized in SSB groups,
an SSB group of the SSB groups includes N SSB indices in N SSB occasions,
the SSB group spans M frequency occasions and K time occasions, where N≤M·K, and M>1;
receiving, in frequency occasion m1ᵢ and in time occasion k1ᵢ, SSB index i in a first SSB group with index s₁; and
receiving, in frequency occasion m2ᵢ and in time occasion k2ᵢ, SSB index i in a second SSB group with index s₂,
wherein m1ᵢ≠m2ᵢ.

15. The method of claim 14, further comprising:
receiving, in frequency occasion m3ᵢ and in time occasion k3ᵢ, SSB index i in a third SSB group with index s₃,
wherein
$$⌊ \frac{{s}_{1}}{L} ⌋ = ⌊ \frac{{s}_{3}}{L} ⌋ ,$$
where L>1,
wherein m3ᵢ=m1ᵢ and
wherein k3ᵢ=k1ᵢ.

16. The method of claim 14, further comprising receiving N SSB indices in one frequency occasion across M SSB groups.

17. The method of claim 14, further comprising receiving N SSB indices in M1 frequency occasions cycled across
$$⌈ \frac{M}{M 1} ⌉$$
SSB groups.

18. The method of claim 14, wherein searching the SSB indices in the SSB occasions further comprises searching all frequency occasions and all time occasions in the SSB group.

19. The method of claim 14, wherein:
searching the SSB indices in the SSB occasions further comprises searching one frequency occasion and all time occasions in the SSB group, and
the searched frequency occasion has a same frequency across SSB groups.

20. The method of claim 14, wherein:
searching the SSB indices in the SSB occasions further comprises searching one frequency occasion and all time occasions in the SSB group, and
the searched frequency occasion follows a hopping pattern across the SSB groups.
